(19) United States
(12) Patent Application Publication
(10) Pub. No.: US 2017/0039594 A1
(43) Pub. Date: Feb. 9, 2017

(54) LOCATION-BASED ELECTRONIC COMMERCE SERVICE DRIVEN BY AN EVENT

(71) Applicant: AT&T Intellectual Property I, L.P., Atlanta, GA (US)

(72) Inventors: Venson Shaw, KIRKLAND, WA (US); Sangar Dowlatkhah, ALPHARETTA, GA (US)

(21) Appl. No.: 14/817,859

(22) Filed: Aug. 4, 2015

(51) Int. Cl. G06Q 30/02; G06Q 50/00; H04W 4/02

(52) U.S. Cl. CPC G06Q 30/0261; H04W 4/02; G06Q 30/0252; G06Q 30/0267; G06Q 50/01

(57) ABSTRACT

Distribution of promotional content and/or location information associated with devices in response to, for example, a social event or another type of event. Commerce transactions and/or non-commerce transactions associated with the promotional content can be performed. The location information can be associated with a current location of a mobile device related to the social event. The promotional content can be provided by a network and can be based on consumer preferences associated with the mobile device. The promotional content and the location information can be provided to user devices having a social network relationship with the mobile device. Information related to the social event also can be distributed. Certain type of events can include emergency alerts related to the mobile device. An estimate of the current location of the mobile device can be distributed to user devices while the emergency alert is active.

### TECHNICAL FIELD

The subject application relates to electronic commerce and other transactions responsive to, for example, a social event or another type of event.

### BACKGROUND

Distribution of advertisements, coupons, or other incentivation information to mobile devices generally relies on specialty software application. In addition, incentivation information can depend on location of a mobile device. Thus, when the mobile device is turned off or the specialty software application is unavailable, a network or a service related to the specialty software application may not be able to determine a location of the mobile device or distribute incentivation information to it, much less distribute related incentivation information to other related mobile devices.

### BRIEF DESCRIPTION OF THE DRAWINGS

FIG. 1 presents an example of an operational environment for determination of a location of a mobile device in accordance with one or more embodiments of the disclosure.

FIG. 2 presents an example of a communication component for determination of a location of a mobile device in accordance with one or more embodiments of the disclosure.

FIG. 3 presents an example of a system for determination of a location of a mobile device in accordance with one or more embodiments of the disclosure.

FIG. 4 presents another example of a communication component for determination of a location of a mobile device in accordance with one or more embodiments of the disclosure.

FIGS. 5-6 present an example of a location component for determination of a location of a mobile device in accordance with one or more embodiments of the disclosure.

FIG. 7 presents an example of an operational environment for electronic commerce and other transactions in accordance with one or more embodiments of the disclosure.

FIGS. 8-9 present examples of a system for electronic commerce and other transactions in accordance with one or more embodiments of the disclosure.

FIG. 10 presents an example of an operational environment in which commerce, location, and transactional information can be distributed in accordance with one or more embodiments of the disclosure.

FIGS. 11-12 present example user interfaces that permit consumption of information associated with an event in accordance with one or more embodiments of the disclosure.

FIG. 13 presents an example of an operational environment for distribution of location information in accordance with one or more embodiments of the disclosure.

FIG. 14 presents an example of a method for determining a location of a mobile device in accordance with one or more embodiments of the disclosure.

FIG. 15 presents an example of a method for handling an exception in determining a location of a mobile device in accordance with one or more embodiments of the disclosure.

FIG. 16 presents an example of method for conducting electronic commerce in accordance with one or more embodiments of the disclosure.

FIG. 17 presents an example of method for supplying electronic commerce information and/or information associated with an event in accordance with one or more embodiments of the disclosure.

FIG. 18 presents an example of method for supplying location information in response to an event in accordance with one or more embodiments of the disclosure.

FIG. 19 presents an example of a computing environment that can implement determination of a location of a mobile device in accordance with one or more embodiments of the disclosure.

FIG. 20 illustrates another example of a computing environment in accordance with one or more embodiments of the disclosure.

### DETAILED DESCRIPTION

The disclosure recognizes and addresses, in at least certain embodiments, the issue of conducting electronic commerce or other type of transactions in response to a social event or another type of event in which access to a service provided by a network may not be available. Embodiments of the disclosure permit or otherwise facilitate distribution of promotional content and/or location information associated with devices in response to, for example, a social event or another type of event. Commerce transactions and/or other type of transactions associated with the promotional content can be performed. The location information can be associated with a current location of a mobile device related to the social event. The promotional content can be provided by an electronic commerce platform and can be based on consumer preferences associated with the mobile device. The promotional content and the location information can be provided to a group of user devices having a social network relationship with the mobile device. The group of user devices can be addressed or otherwise treated as a single entity within the social event (e.g., a sporting event or a tradeshow). Information related to the social event also can be distributed. Certain events can include emergency alerts related to the mobile device. An estimate of the current location of the mobile device can be distributed to remote devices while the emergency alert is active.

As described in greater detail below, embodiments of the disclosure can determine a group of devices associated with a specific user equipment in response to the social event, and can provide location information and/or content to at least one of the group of subscribers. The location information can be indicative or otherwise representative of the location of at least one of the group of subscribers and/or the location of a business associated with the social event. The content be determined by the location information, and can include advertisements, coupons or other incentivation media, and/or other type of promotional media of such a business. The location information and content can be provided during the social event or a portion thereof. The social event (e.g., a professional meeting, a sports event, an entertainment event, or the like) can be associated with a venue and can include multiple entities having a mutual social networking association. As such, the group of devices can be respectively associated with a group of subscribers, each having a social networking association with a subscriber associated with the specific user equipment. For instance, the group of subscribers can include friends, family, relatives, co-workers, or the like.

A network architecture can provide a service that can determine and/or communicate (e.g., broadcast) location information indicative of the position of at least one of a group of devices associated with a user equipment within a venue where a social event is being hosted. The service can determine and/or communicate (e.g., broadcast) venue information and/or event information. The venue information can characterize the event's venue, including indoor and/or outdoor landmarks. The event information can include, for example, a listing of participants in the social event (e.g., vendors, speakers, and the like); a schedule of activities within the social event (e.g., presentations, panels, banquets, and the like); a listing of organizers of the social event; or the like. Further or in yet other embodiments, the service can determine a business associated with the social event, and can access and/or communicate promotional content related to the business to one or more of the group of devices. The network architecture also can permit conducting a commercial transaction between a device that receives the promotional content and the business. The group of devices and/or the business can be determined based on a user profile of the user equipment, and the location information can be generated, for example, based on positioning information provided by each of the group of devices.

While various aspects of the disclosure are illustrated in connection with user equipment, such as a smartphone or a tablet computer, the disclosure is not limited in that respect and features of the disclosure can be implemented in any mobile device, such as a wearable device (e.g., a watch, a medical device), an infotainment vehicular system, a vehicular access point (AP) device, a navigation mobile device, a gaming mobile console, or the like. In addition, embodiments of the disclosure are not limited to a specific technology or network for wireless communication. Embodiments of the disclosure can be implemented in substantially any or any wireless communication network (second-generation (2G), third-generation (3G), or fourth-generation (4G) network and variant thereof) and non-wireless communication network (broadband network, a cable network, a conventional Public Switched Telephone Network (PSTN), etc.). In addition, such aspects, features, or advantages can be realized irrespective of telecommunication radio technology or wireline technology. Examples of such radio technologies or wireless networks include Femtocell technology, Wi-Fi, Worldwide Interoperability for Microwave Access (WiMAX); Enhanced General Packet Radio Service (Enhanced GPRS); Third Generation Partnership Project (3GPP) Long Term Evolution (LTE); 3GPP Universal Mobile Telecommunications System (UMTS); Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); Global System for Mobile Communication (GSM) Enhanced Data Rate for GSM Evolution (EDGE) RAN or GERAN; UMTS Terrestrial Radio Access Network (UTRAN); or LTE Advanced. Examples of wireline technology include fiber-optic backbone networks, digital subscriber line (DSL) networks, T1/E1-based networks, Ethernet backbone networks, etc. Embodiments or related aspects also can be advantageously implemented in legacy telecommunication technologies.

Implementation of embodiments and/or aspects thereof of the disclosure can provide various improvements over conventional technologies for conducting transactions and/or supplying information to a mobile device. In one example, customized information associated with an event can be provided to user devices without reliance on an express request for such information from one or more such devices. The event information can include venue information, event information other than the venue information, and/or information associated with vendors or other type of entities associated with the event. In another example, the group of user devices can be identified or otherwise selected based at least on a social network relationship between devices in the group of user devices. The group of user devices can be treated as a single logical entity in view of the defined social networking relationship between a first user device in the group of user devices and a second user device in the group of user devices. In yet another example, the information that is provided can be based on location of a user device of the group of user devices. In addition, the location can be determined or otherwise obtained by a source of the information without reliance on a specialty application or another type of software module configured in the user device. In yet another example, location information indicative or otherwise representative of a current location of the user device can be sent (e.g., broadcasted) to other user devices in the group of devices. The location information can be sent throughout the duration of the event or at any other time relative to commencement or termination of the event. In still another example, an authorization configuration associated with the user device can be automatically configured in order to permit tracking of location of the user device. For instance, the authorization configuration or information associated therewith can be remotely configured, without approval or intervention of the user device.

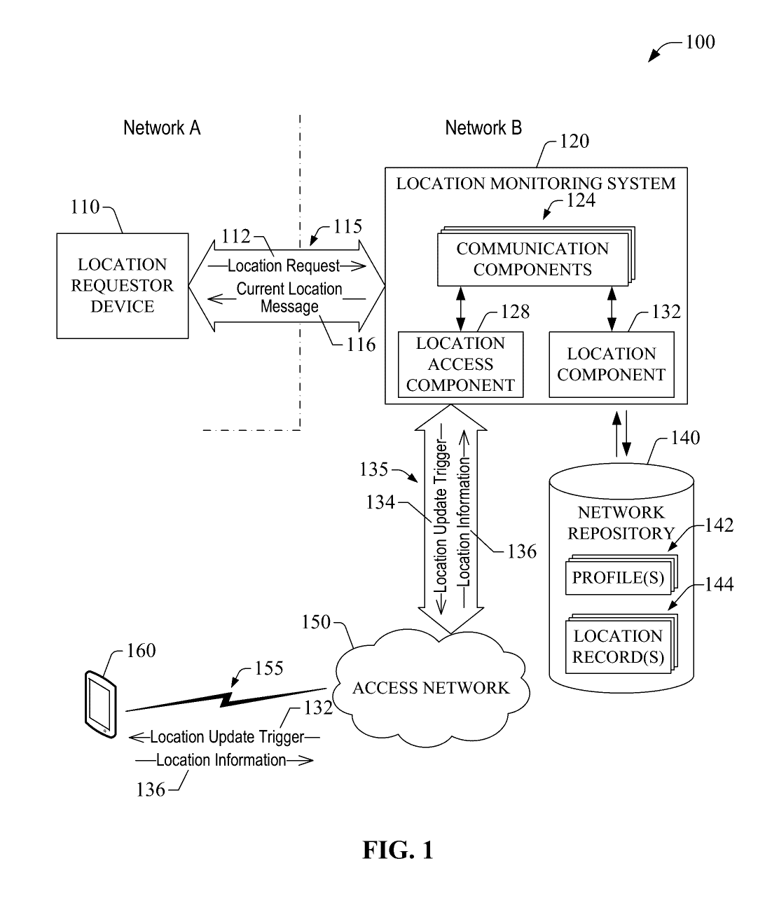

With reference to the drawings, FIG. 1 illustrates an example of an operational environment 100 for determination of a location of a mobile device in accordance with one or more embodiments of the disclosure. The operational environment 100 can rely, for example, on exchange of communication messages or other types of communications between different devices and/or components in order to generate an estimate of a current location of mobile device in response to at least one of the messages. As illustrated, a location requestor device 110 can send a location request 112 to a location monitoring system 120. The location requestor device 110 can be associated with a platform architecture or network (represented with a “Network A” label in FIG. 1) having a specific functionality and/or configured to provide specific services. In certain embodiments, the location requestor device 110 can be deployed (e.g., installed, configured, and accepted) at a platform for electronic commerce. In other embodiments, the location requestor device 110 can be deployed at a platform or network for law enforcement. The location monitoring system 120 can be deployed in another platform architecture or network (represented with a “Network B” label in FIG. 1) different from that in which the location requestor device 110 is deployed. Communications links 115 that can communicatively couple the location requestor device 110 and the location monitoring system 120 can permit transmission of the location request 112. The communication links 115 can be embodied in or can include wireless links (e.g., deep-space wireless links and/or terrestrial wireless links); wireline links (e.g., optic-fiber lines, coaxial cables, and/or twisted-pair lines); routers; switches; server devices; aggregator devices; a combination of the foregoing; or the like.

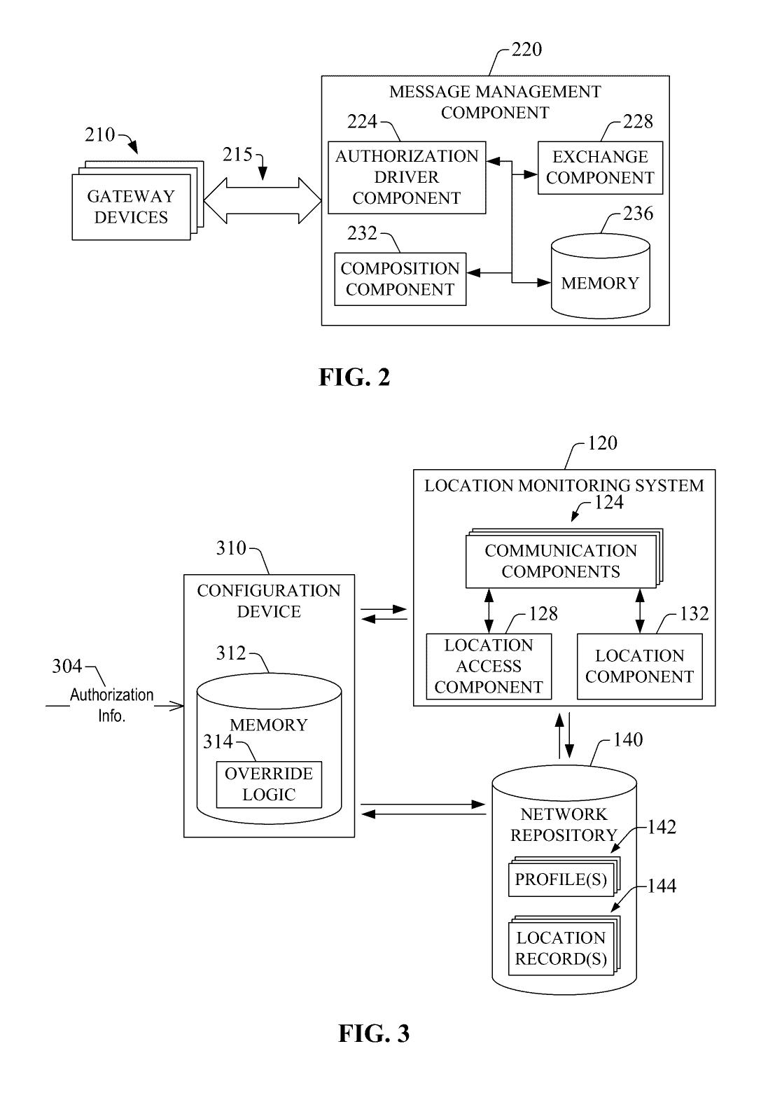

In certain embodiments, the location request 112 can be embodied in or can include a short message service (SMS) message or another type of communication message directed to a mobile device 160. Suitable types of communication messages include, for example, a multimedia messaging service (MMS) message, a session initiation protocol (SIP) message, an unstructured supplementary service data (USDD) message, an email message, or the like. As such, the communication request 112 can be addressed to a defined communication address of the mobile device 160—e.g., a telephone number, an international mobile subscriber identity (IMSI), an Internet protocol (IP) address, a media access control (MAC) address, a session initiation protocol (SIP) address, or the like. The location monitoring system 120 can receive the location request 112 and can utilize or otherwise leverage the communication address to process the location request 112. Specifically, in certain embodiments, the location monitoring system 120 includes communication components 124, at least one of such components can receive the location request 112. A location component that receives the location request 112 can be configured to receive a communication according to a communication protocol that the location requestor device 110 relies on to send the location request 112. The communication protocol can be embodied in or can include short message peer-to-peer (SMPP) protocol, simple mail transport protocol (SMTP), hypertext transfer protocol (HTTP), Internet protocol (IP), intern& control message protocol (ICMP), mobile application part (MAP) protocol, or the like. As such, in one example, the location component that receives the location request 112 can be embodied in or can constitute a web-based gateway device. In another example, such a location component can be embodied in or can constitute a mobile switching center (MSC) device. More generally, in at least certain embodiments, such as the example embodiment shown in FIG. 2, the communication components 124 can include gateway devices 210 communicatively coupled to a message management component 220 via communication links 215. The communication links 215 can include wireless link(s), wireline link(s), and/or reference link(s). A first gateway device of the gateway devices 210 can receive a communication message from a device external to the location monitoring system 120, and the message management component 220 can process the communication message and/or can deliver it to a second gateway device of the gateway devices 210. The message management component 220 also can send the communication message to a component within the location monitoring system 120. The second gateway device can send the originally received message or a different message to another device external to the location monitoring system 120.

With further reference to FIG. 1, the location monitoring system 120 can include a location access component 128 that can determine if the location request 112 is to be fulfilled. Specifically, the location access component 128 can determine if location information associated with the mobile device 160 (e.g., a smartphone or a tablet computer) can be provided to the location requestor device 110 in response to the location request 112. To that end, in certain embodiments, the location access component 128 can receive an instruction or another type of signaling to perform such a determination from a communication component of the communication components 124. For instance, in one embodiment, such as the embodiment shown in FIG. 2, the communication component that sends the instruction or other signaling can be embodied in the message management component 220, in which component an authorization driver component 224 can send the instruction or the signaling. In response to such an instruction or signaling, the location access component 128 can access authorization information related to tracking location of the mobile device 160, and can utilize the access authorization information to ascertain that location of the mobile device 160 can be tracked or that such a location cannot be tracked. In a scenario in which the location of the mobile device 160 can be tracked, the location request 112 can be fulfilled. The access authorization information can be included in a profile of mobile device 160. The profile can be retained or otherwise recorded in one or more computer-accessible memory elements 142 (referred to as profile(s) 142) within a network repository 140. The profile(s) 142 can embody or can constitute, in one example, a database (relational or unstructured, for example) within a home subscriber server (HSS) or a home location register (HLR). In one implementation, the network repository 140 can be embodied in or can include distributed computer-accessible information storage apparatuses, such as a consolidated network repository (CNR), which is one implementation of cloud storage.

In one scenario, access authorization information that is acquired by the location access component 128 can include opt-out information (e.g., data or metadata) that specifies that tracking location of the mobile device 160 is not permitted. In response, the location access component 128 can determine that location information associated with the mobile device 160 is not to be provided in response to the location request 112. In addition or in other scenarios, the location access component 128 can implement an exception handling process, which can result in rejection of the location request 112. The exception handling process can be specific to the type of location requestor device 110. For instance the exception handling process implemented for user equipment can be different from the exception handling process implemented for customer premises equipment or to a network device. In certain implementations, depending on the location requestor device 110, implementation of the exception handling can have additional or alternative outcomes besides rejection of the location request 112. Specifically, in certain embodiments, such as the example embodiment shown in FIG. 3, implementation of the exception handling cause a configuration device 310 to override the opt-out information and modify the authorization information present in the device profile associated with the mobile device 160. To such an end, in one example, the configuration device 310 can be communicatively coupled to the location access component 128 and can execute override logic retained in a memory element 314 (referred to as override logic 314) within one or more computer-accessible storage devices 312 (referred to as memory 312). More specifically, in response to the opt-out information or absence of permission to track location of the mobile device 160, the configuration component 310 can receive, from the location access component 128, signaling or another type of directive to execute the override logic. Execution of the override logic can cause the configuration device 310, or a component therein or functionally coupled thereto, to modify the profile associated with the mobile device 160 to include opt-in information (e.g., data or metadata) indicative or otherwise representative of permission to track the location of the mobile device 160. In addition, the implementation of the exception handling process can cause the location access component to retry accessing the authorization information, which after the modification performed by the configuration component 310, can result in the location access component 128 accessing such opt-in information. The override of authorization information can be implemented in emergency scenarios in which availability of an estimate of the current location of the mobile device 160 can be critical to the integrity of the mobile device 160 or a person that may be carrying the mobile device 160.

Addition or other outcomes of an exception handling process implemented by the location access component 128 can include communication with an agent device of a service provider that provide wireless service or other types of services to the mobile device 160. The communication can convey to the agent device that tracking of the location of the mobile device 160 is not permitted. In response, the agent device (not shown) can send authorization information 314 to the configuration device 310, where the authorization information can include opt-in information. The configuration device 310 can utilize or otherwise leverage the authorization information 314 to modify a device profile of the mobile device 160 in order to permit tracking of the location of the mobile device 160. In certain scenarios, the agent device can send the authorization information 314 on-demand, in response to a request from a device associated with the mobile device 160. Such a device can be billed for the submission of the authorization information 314 and the re-configuration of the device profile of the mobile device 160.

With reference again to FIG. 1, in other scenarios, access authorization information that is acquired by the location access component 128 can include opt-in information that specifies that tracking location of the mobile device 160 is permitted. The opt-in information also can specify the scope of permission to track the location of the mobile device 160. For instance, the opt-in information can determine a period during which location of the mobile device 160 can be monitored, a group of devices permitted to monitor the location of the mobile device 160, conditions or events in response to which the location of the mobile device 160 can be tracked, a combination thereof, or the like. The group of devices can include, for example, a device associated with a platform for electronic commerce, a device associated with a platform for law enforcement, a user equipment associated with the mobile device 160, and the like. A configuration component (not shown in FIG. 1) can permit configuring the opt-in information to specify tracking period, a device to be included in the group of devices, one of such conditions or events, a combination thereof, or the like. For instance, the configuration component can receive a telephone number or another communication address (e.g., a MAC address) of a user equipment that can be permitted to track the location of the mobile device 160. The configuration component can be embodied in, for example, the configuration device 310 shown in FIG. 3, and a communication address of user equipment permitted to track the location of the mobile device 160 can be received via authorization information 314.

In response to opt-in information, the location access component 128 determines that location information associated with the mobile device 160 can be provided in response to the location request 112. Therefore, the location access component 128 can signal or otherwise indicate to a communication component of the communication components 124 that an estimate of the current location of the mobile device 160 is to be determined. To that end, in certain embodiments, the location access component 128 can direct or otherwise cause the communication component to send a location update trigger 134 to the mobile device 160. The location update trigger 134 can cause the mobile device 160 to perform a location update, which can result in generation of location information representative or otherwise indicative of a current location of the mobile device 160. In response to the location update, the mobile device 160 can send at least a portion of such information. As an example, the communication component can be embodied in or can include the message management component 220 shown in FIG. 2, which can include a composition component 232 that can generate the location update trigger 134. In such an embodiment, prior to generation of the location update trigger 134, the authorization driver component 224 can receive the indication that the estimate of the current location of the mobile device 160 is to be determined. In certain embodiments, the second message can be embodied in a control message within a standardized protocol for generation of a location update of the mobile device, such a location area update (LAU) in UMTS or a location determination procedure in E-911. The location update trigger 134 can be embodied in or can include, for example, a communication message directed to the mobile device 160, such as a SMS message, an MMS message, a SIP message, a USDD message, an email message, or the like. It should be appreciated that, in one implementation, the location update trigger 134 can coincide with the location request 112. Thus, the composition component 232 can replicate the location request 112 and can assign the replicated location request 112 as the location update trigger 134. In the alternative, in such an implementation, the message management component 220 can circumvent the composition component 232, and can send the location request 112 as the location update trigger 134.

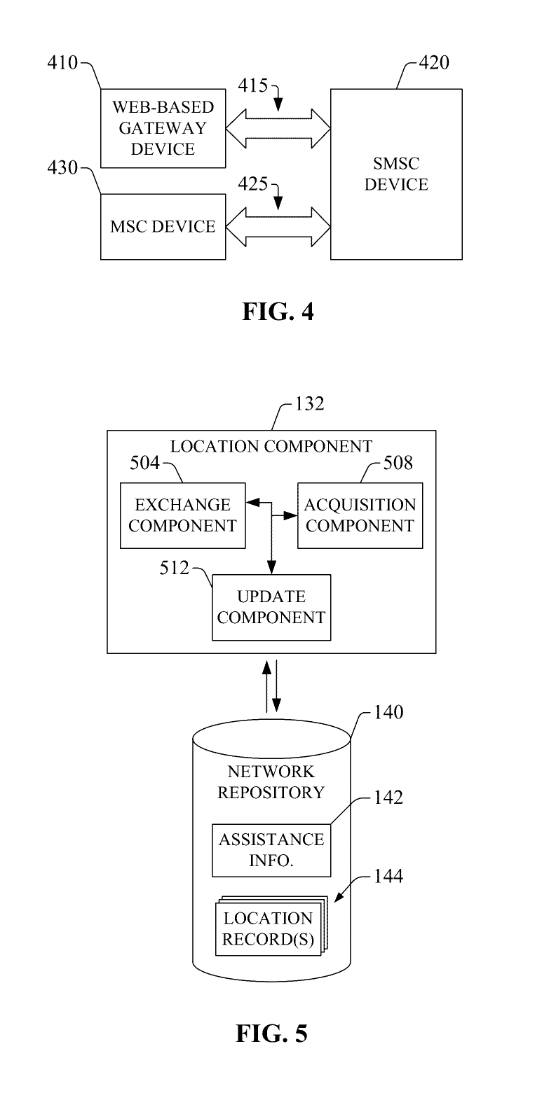

The communication component that can send the location update trigger 134 (e.g., the message management component 220 shown in FIG. 2) can leverage another communication component of the communication components 124 to route the location update trigger 134 to a network device within an access network 150 that is communication with the mobile device 160. The network device (not depicted in FIG. 1) can be embodied in a base station or an access point device, and can send the location update trigger 134 to the mobile device 160 via a downstream link (DL) of wireless links 155. As an illustration, in certain embodiments, such as the embodiment shown in FIG. 2, a delivery component 228 within the message management component 220 can access routing information from the network repository 140 shown in FIG. 1. For instance, the routing component can be retained in a home location register (HLR; not depicted in FIG. 1). The routing information can permit determining a gateway device of the gateway devices 210 that is configured to send information to the network device. As another illustration, FIG. 4 presents an example embodiment of the communication devices 124 in accordance with at least some of aspects described herein. Specifically, the communication component that sends the location update trigger 134 can be embodied in or can constitute a short message service center (SMSC) device 420, and the communication component that routes the location update trigger 134 can be embodied in or can constitute a MSC device 430. In addition, a web-based gateway device 410 can receive the location request 112. In such an example embodiment, the location update trigger 134 can be or can include a SMS message. One or more communication links 415 can couple communicatively the web-based gateway device 410 and the SMSC device 420. Thus, the communication link(s) 415 can permit exchange of information (data, metadata, and/or signaling) between such devices. Similarly, one or more communication links 425 can couple communicatively the MSC device 430 and the SMSC device 420. Thus, the communication link(s) 425 can permit exchange of information (data, metadata, and/or signaling) between such devices.

Continuing with FIG. 1, the mobile device 160 can receive the location update trigger 134 and, in response, can generate location information indicative or otherwise representative of a current location of the mobile device 160. In certain implementations, the mobile device 160 can process payload data received in the location update trigger 134, and for payload data including a defined keyword (e.g., “locate” or “position”), the mobile device 160 can generate the location information. The location information can be generated in numerous ways, depending on architecture of the mobile device 160 and/or communication signals available thereto. In a scenario in which the mobile device 160 includes a satellite-signal receiver, the mobile device 160 can utilize the satellite-signal receiver to access global positioning system (GPS) signals and/or signals from other GNSSs, such as BeiDou navigation satellite system (BDS), quasi-Zenith satellite system (QZSS), and/or GPS aided geo augmented navigation (GAGAN) system. A processor and/or dedicated hardware in the mobile device 160 can process the GPS signals or signals from another GNNS in order to generate location information indicative of a current location of the mobile device 160. The location information represents an estimate of the current location of the mobile device 160. In the alternative, the mobile device 160 can send the GPS signals or the signals from another GNNS to the location component 132, which can determine an estimate of the current location of the mobile device 160. In such a scenario, the location information generated by the mobile device 160 is embodied in the satellite-based signals accessed by the mobile device 160.

In certain instances in which signals from a GNNS have poor quality (e.g., environment causes significant scattering) or are received from a subset of the satellites in the GNNS, the mobile device 160 can receive assistance information from the location component 132. The assistance information can be indicative or otherwise representative of position of one or more satellites of the GNNS (e.g., almanac and/or ephemeris data) and/or reference time. The mobile device 160 can process the assistance information in order to generate location information indicative of a current location of the mobile device 160.

Regardless of the specific type of location information generated at the mobile device 160, the mobile device 160 can send location information 136 indicative or otherwise representative of the current location of the mobile device 160 to the location component 132. Specifically, in one implementation, the location information 136 can be sent wirelessly, via an upstream link (UL) of the wireless links 155, to a network device (e.g., a base station, an access point device, or a location measurement unit (LMU)) of the access network 150. In certain embodiments, the access network 150 can be embodied in a radio access network (RAN) that operates in accordance with one or more radio technology protocols for wireless communication. The network device can send the information 136 to a first communication component (e.g., a MSC device) of the communication components 124, which in turn can send the location information 136 to a second communication component (e.g., SMSC device) of the communication components 124. The second communication component can send the location information 136 to the location component 132. In one embodiment, such as the example embodiment shown in FIG. 2, the exchange component 228 can receive the location information 136 and can relay the received information to the location component 132.

In other instances in which signals from a GNNS are unavailable or in embodiments in which the mobile device 160 lacks a satellite-signal receiver, the mobile device 160 can utilize or otherwise leverage a transceiver configured to transmit and receive terrestrial radiofrequency signals in order to generate location information. Accordingly, in one implementation, in response to the location update trigger 134, the mobile device 160 can send pilot signals to a group of network devices (e.g., multiple base stations or AP devices, or multiple LMUs) of the access network 150. The access network can determine timing information indicative of the time of arrival of the pilot signals at each of the group of network devices, and can send such information to the location component 132. In response, the location component 132 can determine, for example, a time difference of arrival (TDOA) for each pair of the group of network devices, and can implement a multilateration process in order to determine an estimate of a current location of the user equipment. In other implementations, the mobile device 160 and the location component 132 can implement advanced forward link trilateration (AFLT) in order to generate an estimate of the current location of the mobile device 160. Thus, the mobile device 160 can probe (e.g., receive and analyze) pilot signals from the group of network devices, which can result in timing information and/or distance information indicative or otherwise representative of a distance from a network device (e.g., a base station) to the mobile device 160. The timing information and/or the distance information can embody or can constitute the location information 136, and the mobile device 160 can send such information to the location component 132. In response, the location component 132 can perform a trilateration process using at least a portion of the location information 136 in order to generate the estimate of the current location of the mobile device 160.

As described herein, the location component 132 can receive location information 136 from the mobile device 160 and can determine an estimate of the current location of the mobile device 160 using the location information 136. Such an estimate can be formatted geographic coordinate format (e.g., latitude, longitude, and/or altitude) or in civic address format (e.g., civic number, street name, and ZIP code). In embodiments in which the mobile device 160 can receive signals from a GNNS, the location information 136 can embody or can constitute the estimate of the current location of the mobile device 160. As such, the location component 132 can assign the received location information 136 to a record indicative of the estimate of the current location of the mobile device 160. Such a record can be retained at the network repository 140, within one or more memory elements 144 (referred to as location record(s) 144). In embodiments in which satellite signals are unavailable or the mobile device 160 lacks a satellite-signal receiver, the location component 132 can process at least a portion of location information 136 in order to generate the estimate of the current location of the mobile device 160. More specifically, in certain implementations, the location component 132 can implement multilateration (e.g., TDOA multilateration or AFLT) to determine such an estimate.

As an illustration, an example embodiment of the location component 132 is shown in FIG. 5. An exchange component 504 can receive and send information (e.g., data, metadata, and/or signaling) to a communication device (e.g., message management component 220). The information can include, for example, an instruction or another type of directive to determine the estimate of the current location of the mobile device 160, as described herein. In scenarios in which the mobile device 160 can generate location information indicative of such an estimate, the exchange component 504 can receive the location information (e.g., location information 136) and can provide the information to an update component 512 that retain the estimate of the current location of the mobile device 160 within the location record(s) 144. In one implementation, the location record(s) 144 can be embodied in or can constitute an automatic location information (ALI) database. As illustrated in FIG. 5, the location component 132 can include an acquisition component 508 that can send assistance information to the mobile device 160, as described herein. Assistance information can be retained a memory element 142 (referred to as assistance info. 142) within the network repository 140. Assistance information also can be retained in one or more computer-accessible memory devices within the location component 132. In addition, the acquisition component 508 can generate the estimate of the current location of the mobile device 160 in scenarios in which GNNS signals are unavailable to the mobile device 160, as described herein.

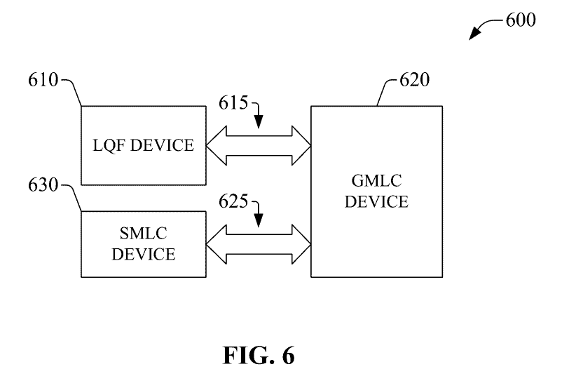

As another illustration, a distributed embodiment of location component 132 is shown in FIG. 6. The location component 132 can include a location query function (LQF) device that can receive an instruction to determine a current estimate of the location of the mobile device 160. The LQF device 610 can cause a communication component (e.g., a SMSC device) to send the location update trigger 134 (e.g., SMS message) to the mobile device 132. As described herein, the location update trigger 134 can cause the mobile device 160 to perform a location update. Therefore, in one implementation, the mobile device 160 can exchange information with a serving mobile location center (SMLC) device 630 in order to generate location information representative of the current location of the mobile device 160, as described herein. The SMLC device 630 can send the location information to a gateway mobile location center (GMLC) device 620, which can update a location record (e.g., one of the location record(s) 144) associated with the mobile device 160. One or more communication links 625 can permit exchange of information between the GMLC device 620 and the SMLC device 630. The LQF device 610 can access the updated location record and can send such a record to the location access component 128.

Regardless of the specific embodiment of the location component 132, upon or after an estimate of the current location of the mobile device 160 becomes available in response to the location update trigger 134 (e.g., a SMS message or control information), the location component 132 can send the estimate to the location requestor device 110. To that end, in one implementation, the location component 132 can send the estimate of the current location of the mobile device 160 to a first communication component of the communication components 124. The first communication component (e.g., a SMSC device) can compose a communication message including the estimate of the current location of the mobile device 160. More specifically, as an illustration, in an embodiment in which the first communication component is embodied in or includes the message management component 220 shown in FIG. 2, the exchange component 228 can receive the estimate of the current location of the mobile device 160. The exchange component 228 can provide the estimate to the composition component 232, which can compose the communication message. The communication message can be referred to as current location message 116, and is addressed or otherwise directed to a defined communication address of the location requestor device 110, such as a telephone number, an IMSI, an IP address, a MAC address, a SIP address, or the like. The current location message 116 can be embodied in or can include, for example, a SMS message, a MMS message, a SIP message, a USDD message, an email message, or the like. Accordingly, the current location message 116 can be composed according to a defined communication protocol can be embodied in or can include SMPP protocol, SMTP, HTTP, IP, ICMP, MAP, or the like. In addition, the current location message 116 can include a hyperlink associated with geographic coordinates indicative of the estimate of the current location of the mobile device 160. The hyperlink can be configured to be executed by a web application (e.g., a HTTP application or a MAP application) at the location requestor device.

It should be appreciated that the first communication component that composes the current location message 116 can be the same communication component (e.g., message management component 220) that can generate and/or route the location update trigger 134. In addition, the first communication component can send the current location message 116 to a second communication component of the communication components 124. The second communication component (e.g., a MSC device) can send the current location message 116 to the location requestor device 110. It should be appreciated that the second communication component (e.g., a web-based gateway device) can be the same communication component that can receive the location request 112. In certain instances, with further reference to FIG. 2 as an illustration, the second communication component can be embodied in or can include a gateway device of the gateway devices 210.

The location requestor device 110 in the operational environment 100 can receive the current location message 116 and, thus, the location request 112 can be fulfilled. It should be appreciated that the location request 112 can be fulfilled without reliance on dedicated location service software (e.g., a specialty software application) being configured and/or executed in the mobile device 160. Instead, as described herein, the location request 112 can be fulfilled by validating a preconfigured permission to track the location of the mobile device 160, and exchanging suitable messages between the location requestor device 110, the location monitoring system 120, and the mobile device 160. It should further be appreciated that the location request 112 can be fulfilled without intervention of an end-user associated with the mobile device 160, such as configuring a location tracking preference at the mobile device 160 within a specialty software application, or selecting a generic location based service at the mobile device 160. By fulfilling the location request 112, the location monitoring system 120 can permit, for example, tracking the location of the mobile device 160 in response to certain events, such as the mobile device 160 being stolen or lost, an end-user known to carry the mobile device 160 being missing, or occurrence of natural disaster or other type of emergency (e.g., riots or a terrorist attack) in an area in which the mobile device 160 is known to be operating.

The location requestor device 110 can implement various processes based on the availability of the location request 112. For example, in an embodiment in which the location requestor device 110 is embodied in a device associated with a platform for electronic commerce, the device can provide an estimate of the current location of the mobile device 160 to affiliate devices associated with affiliate platforms for electronic commerce. In addition or in the alternative, the device can supply various types of promotional content to the mobile device 160 based on the estimate of the current location of the mobile device.

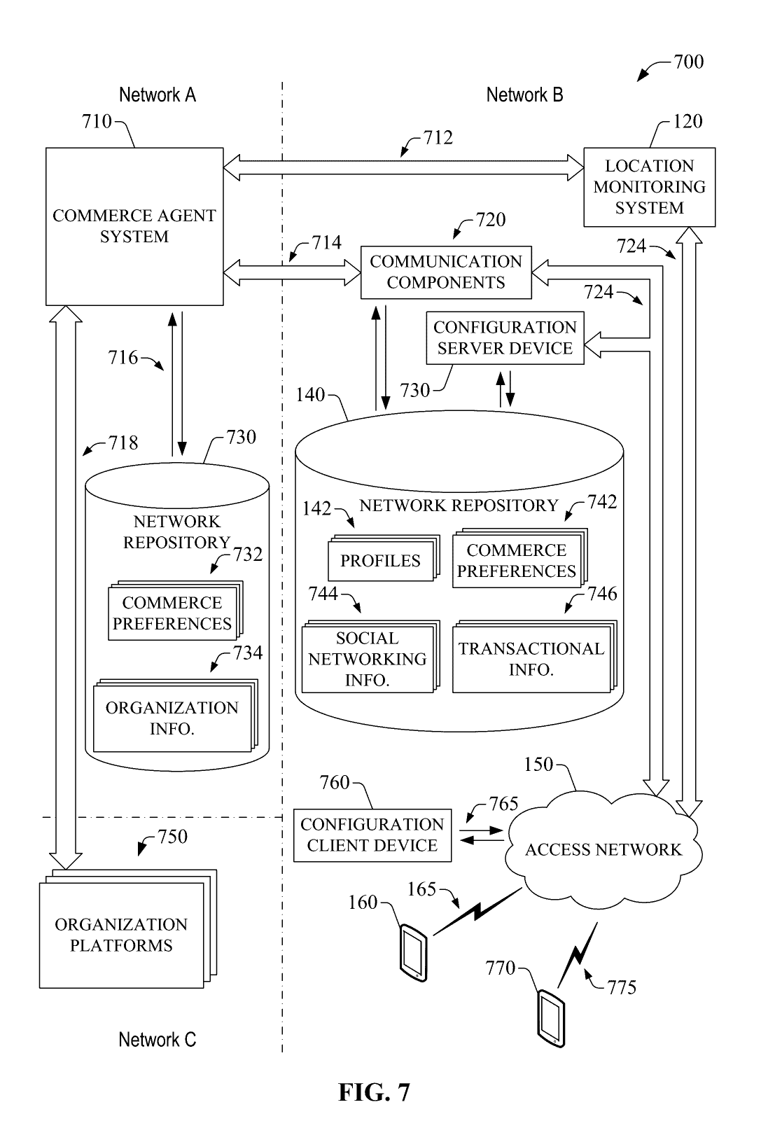

FIG. 7 presents an example of an operational environment 700 for electronic commerce and other transactions in accordance with one or more embodiments of the disclosure. As illustrated, the exemplified operational environment 700 can include a commerce agent system 710 that can be functionally coupled (e.g., communicatively coupled) to network repositories including a variety of information. As described herein, the network repositories can include computer-accessible storage devices and can be configured or otherwise deployed in one or more networks, such as a communication network, and MSO network, a network for electronic commerce, a network for law enforcement, or the like. The network repositories can include a network repository 730 associated with (deployed at, maintained by, etc.) a first network (represented with “Network A”). The communication agent system 710 can rely on communication links 716 to exchange information (e.g., data, metadata, and/or signaling) with the network repository 730. Similar to other communication links described herein, the communication links 716 can include wireless links and/or wireline links. In addition, the network repositories can include the network repository 140, which is associated with a second network (represented with “Network B”). The commerce agent system 710 can exchange information with the network repository 140 via communications links 718 and one or more communication components 720. It should be appreciated that, in certain embodiments, the communication links 718 can be structurally and/or functionally different from the communication links 716. Similar to other communication links described herein, the communication links 718 can include wireless link(s), wireline link(s) and/or reference link(s). The communication components 720 can include, for example, gateway devices, router devices, a combination thereof, or the like.

The information included in a network repository that can be accessible by the commerce agent system 710 can be specific to the operations of the network in which the network repository is deployed. In certain embodiments, the first network (e.g., Network A) associated with the network repository 730 and can be embodied in or can include a network for electronic commerce or management thereof. As such, in one example, the network repository 730 can include commerce preferences of one or more end-users or other type of consumers or subscribers. The commerce preferences can be retained in one or more memory elements 732 (referred to as commerce preferences 732). In addition or in another example, the network repository 730 can include organization information indicative or otherwise representative of a commercial organization (e.g., a small or medium business) that can provide goods or services. The goods can include consumer goods, industrial goods (automotive goods, construction goods, automation control goods, etc.), or the like. Similarly, the services can include consumer services, business services, or industrial services.

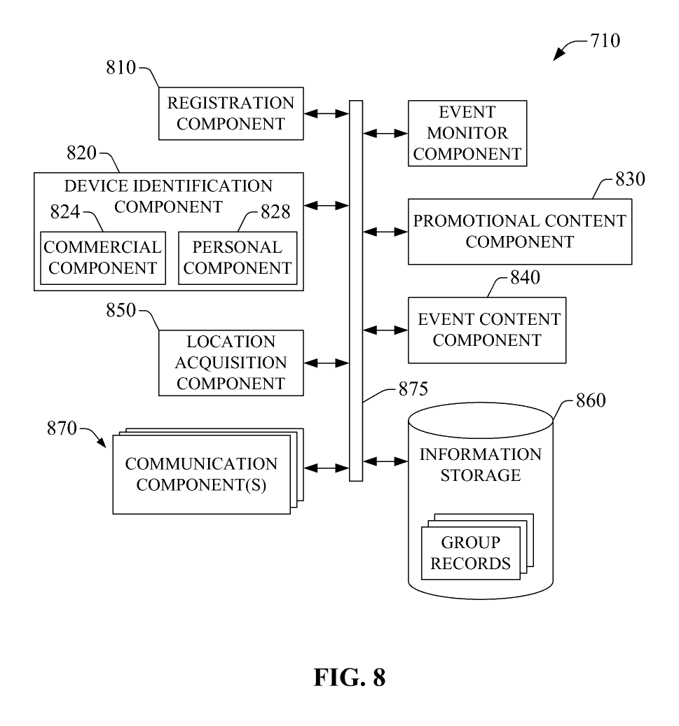

In addition or in other embodiments, the second network (e.g., Network B) associated with the network repository 140 can be embodied in or can include a communication network that can provide wireless communication service, wireline communication service, and/or other services. Accordingly, as described herein, the network repository 140 includes profiles 142. In addition or in other embodiments, the network repository 140 can include commerce preferences of one or more end-users or other type of consumers or subscribers. Such commerce preferences can be retained in one or more memory elements 742 (referred to as commerce preferences 742). Consumer preferences 742 can be similar to consumer preferences 732. Particularly, yet not exclusively, the commerce agent system 710 can access a portion of the information included in the commerce preferences 742 and can store such information within the commerce preferences 732. To that end, in one example embodiment shown in FIG. 8, the commerce agent system 710 can include a group of communication component 870 having a communication component that can permit accessing (e.g., querying, monitoring, or the like) the network repository 140 for information within the commerce preferences 742. Such a communication component can store the accessed information within the commerce preferences 732.

Moreover or in yet other embodiments, the network repository 140 can include social networking information retained in one or more memory elements 744 (referred to as social networking information 744). The social networking information 744 can include, for example, information indicative or otherwise representative of traffic or other types of data generated in response to consumption of a social networking service. Metadata similarly generated also can be retained in the social networking information 744. The social networking service can be permitted or otherwise facilitated by a service (e.g., Internet service) provided by the second network. The social network service can be consumed at the mobile device 160 or at a tethered device in a residence (e.g., a single-family unit or a multiple dwelling unit), a business office, a government building, or another type of facility.

Further or in still other embodiments, the network repository 140 can include transactional information retained in one or more memory elements 746 (referred to as transactional information 746). The transactional information 746 can include, for example, information indicative or otherwise representative of monetary transactions between an organization (or a device thereof or functionally coupled thereto) and a device associated with an end-user. The monetary transaction can be electronic and can include, for example, a purchase or a sale of a good or a service provided by the organization; registration to participate in a professional meeting; or the like. In addition or as another example, the transactional information 746 also can include, for example, information representative of non-monetary transactions between a device and an organization. The non-monetary transactions can include, for example, printing of a coupon associated with the organization or download of coupon information (e.g., media and/or deal information) representative of the coupon; consumption of an advertisement associated with the organization or selection (e.g., click or other type of actuation) selectable indicia associated with the advertisement; consumption of promotional media (e.g., a video segment of an elite athlete endorsing a product) associated with the organization; electronic sharing (in social media or in a point-to-point communication, for example) of coupons or advertisements associated with the organization; enrollment in a loyalty program associated with the organization; application for a credit card (such as a store credit card) or other type of loan associated with the organization; a combination of the foregoing; or the like. It should be appreciated that while monies (or an information representative thereof) may not be exchanged between the organization and the device or another device associated therewith (such as a credit-card processor device), an engagement in a non-monetary transaction can provide value to the device. Monetary and non-monetary transactions can be referred to as commerce transactions because they entail exchange of value between an organization and an end-user. While embodiments and aspects thereof are described herein in connection with commerce transactions, it should be appreciated that the present disclosure is not limited in this respect and any or most any transactions can be contemplated. As such, the commerce agent system 710 can permit implementation of non-commerce transactions in which exchange of information (commercial and/or non-commercial) between devices in accordance with this disclosure can result in a specific outcome.

The information retained in the network repository 730 and the network repository 140 can be rich. Accordingly, the commerce agent system 710 can aggregate or otherwise process such information in a number of ways. Specifically, in certain implementations, the commerce agent system 710 can identify or otherwise determine social events or events of another type using information retained in the social networking information 744 and/or the transactional information 746. In doing so, the commerce agent system 710 can determine specific dates associated with a social event. For instance, the commerce agent system 710 can determine a starting date and/or time and an ending date and/or time of the social event. Identification or otherwise determination of date(s) and/or time(s) associated with a social event can be performed nearly continuously, periodically, or according to a schedule of defined non-periodic times. More generally, block 1410 can be implemented in response to a specific rule, which can be event-based or time-based. The social event can be or can include a sports event, such as the NFL Super Bowl, FIFA World Cup, the Olympics, or the like; an entertainment event (The Oscars, a movie premiere, etc.); a professional meeting (Cleveland Intellectual Property Law Association (CIPLA) Annual Meeting and Dinner, American Physical Society's March Meeting, International Consumer Electronics Show (CES), etc.); a wedding; a group dinner, or the like.

In certain scenarios, the determination can be anonymous in that identifying information of a consumer or subscriber is not accessed or otherwise relied upon by the commerce agent system 710 in order to determine date(s) and/or time(s) associated with a social event. Yet, in other scenarios, a user equipment can be registered with the commerce agent system 710 in order to permit utilization of identifying information and/or a device profile associated with the user equipment in the determination of a social event or other types of events. The identifying information can include, for example, a communication address of the user equipment, a social media identity (e.g., a Twitter handle or a profile name in Facebook, Pinterest, Instagram, or the like) or another identity utilized in a second-life environment (e.g., a fantasy world). As illustrated, in one embodiment, the operational environment 700 can include a configuration server device 730 that can receive registration information from a configuration client device 760, where the registration information is representative of acceptance of disclosure of identifying information of the user equipment (e.g., the mobile device 160). To that end, in one example, the configuration client device 760 can send registration information to a network device (a base station device or an access point device) of the access network 150. In addition, the network device can send the registration information to a communication component of the communication components 720, and the communication component can send the registration information to the configuration server device 730. The configuration server device 730 can store the registration information within a device profile of the profiles 142 associated with the user equipment. In addition or in other implementations, the configuration server device 730 can augment the registration information with identifying information of the user equipment (e.g., a communication address of the user equipment), and can push or otherwise send the augmented registration information to the commerce agent system 710. The configuration server device 730 can send the augmented registration information via at least one of the communication components 720.

In addition to permitting or otherwise facilitating the determination of a social event (e.g., a game of the NBA Finals) specific to a user device registered with the commerce agent system 710, access to a device profile of the user equipment and/or social networking information associated therewith also can permit the commerce agent system 710 to identify a group of user devices that have a social network relationship (or association) with the user equipment. The group of user devices can include, for example, a user device associated with a family member, a user device associated with a relative, a user device associated with professional colleague (such as a coworker or manager), a combination of the foregoing, or the like. For example, a mobile device 770 functionally coupled to the access network 150 can embody a user device of the group of user devices. The commerce agent system 710 can determine the group of user devices in a number of ways. In one implementation, the commerce agent system 710 can leverage service information representative of a communication service utilized by the user equipment. Such information can be retained in the device profile of the user equipment, within the profiles 142. In one example, identifying information of a user device included within a service account of the user equipment can identify or otherwise determine a user device to be included in the group of user devices. As an illustration, in the example embodiment shown in FIG. 8, the commerce agent system 710 can include a device identification component 820 that can determine or otherwise identify the groups of devices. The device identification component 820 can include a personal component 828 that can receive, via one of the communication component(s) 870, for example, the service information discussed above. The personal component 828 can analyze the service information and determine a device to be included in the group of devices.

The service information described herein can include other information that can be utilized or otherwise leveraged to determine the group of device having a relationship. For instance, the service information can include discount information representative of a type of discount applied to the communication service utilized by the user equipment. The discount information can indicate, for example, a name of an organization related to a discount in the cost of the communication service. Therefore, the commerce agent system 710 can correlate the discount information with social networking information (e.g., a profile in LinkedIn of an end-user associated with the user equipment) in order to identify or otherwise determine devices to be included in the group of devices having a relationship with the user equipment.

In addition or in other embodiments, the commerce agent system 710 also can correlate identifying information of an end-user associated with a user equipment (e.g., mobile device 160) and information included in the social networking information 744 in order to determine a group of user devices having a social networking relationship with a user equipment. More specifically, in certain implementations, the commerce agent system 710 can extract identifying information of individuals (e.g., Facebook friends and/or LinkedIn connections) or other types of entities related to such an end-user. Based on the identifying information, the commerce agent system 710 can determine other identifying information representative or otherwise indicative of user devices associated with such individuals. The user devices can embody or otherwise constitute the group of user devices.

As described herein, the group of user devices can include user devices having different types of relationships with the user equipment registered with the commerce agent system 710. A user device in the group can be associated with a family member of an end-user associated with the user equipment, e.g., the device is associated with a personal relationship. Another device can be associated with a colleague of the end-user, and thus, the relationship can be professional. Accordingly, in response to a social event, the commerce agent system 710 can determine if commerce information and/or location information is to be distributed to devices having a certain type of relationship with the user equipment (e.g., mobile device 160). Stated similarly, the commerce agent system 710 can determine if location information and/or commercial information can be appropriate for distribution to a device in the group of devices. For instance, in a scenario in which a social event is a field trip as part of a summer camp, location information of a mobile device operated by a child attending the field trip can be suitable for delivery to a device associated with a parent of the child or another device associated with a declared emergency contact (e.g., regular pediatrician who oversees the child's health or another physician, a dentist, or the like). Yet, such location information can be inappropriate for yet another device associated with a non-emergency contact or a colleague (e.g., a manager or supervisor) of the child's parent. To such an end, in certain embodiments, the commerce agent service 710 can categorize or otherwise rank devices in the group of devices according to relationship relevancy between a device in the group of devices and the user equipment. Based on such a categorization or ranking, the commerce agent system 710 can determine if commerce information and/or location information can be distributed to a device in the group of devices. In certain implementations, the commerce agent system 710 can generate a network graph having nodes representing respective devices of the group of devices, and can determine a geodesic distance between a first node representative of the user equipment and a second node representative of a device of the group of devices. It would be appreciated that certain nodes, such as nearest-neighbor nodes, can be have the same geodesic distance from the first node. For instance, a device associated with a family member included in the service plan of the user equipment can have the same geodesic distance from the user equipment as another device of a colleague of the end-user associated with the user equipment. Therefore, in addition or in other implementations, the commerce agent system 710 can determine a Euclidean distance between nodes connected to the first node. Nodes having the same Euclidean distance in the network graph can have the same relationship relevancy. In any instance, the commerce agent system 710 can determine a metric (e.g., a numeric parameter, a logic parameter, or the like) indicative or otherwise representative of the relationship relevancy or category of a device in the group of devices. In the example embodiment shown in FIG. 8, the personal component 828 can determine relationship relevancy of at least one device in the group of devices as described herein. The commerce agent system can generate a ranking of such metrics.

With further reference to FIG. 7, the commerce agent system 710 can be communicatively coupled with network devices of organization platforms 750. At least one of the organization platforms 750 can be deployed within a third network (labeled as “Network C” in FIG. 7). Communication links 718 can permit exchange of information (e.g., data, metadata, and/or signaling) between the commerce agent system 710 and at least one of the organization platforms. In certain scenarios, such information can include location information representative of a current location of the mobile device 160. The commerce agent system 710 can acquire such information via location monitoring system 120 in accordance with aspects of this disclosure. In response to transmission of the location information, a network device of an organization platform can provide location-based information that can be leveraged in operation of the mobile device 160. In one of such scenarios, the location information can be sent to a network device of an organization for electronic commerce. Specifically, the location information can be sent within a query or other type of request for promotional content (e.g., coupons for a chain restaurant) that can be associated with the current location of the mobile device 160. The commerce agent system 710 can relay at least a portion of the promotional content to the mobile device 160 or a user device having a social networking association with the mobile device 160. In addition or in other embodiments, the commerce agent system 710 also can send information indicative or otherwise representative of consumer preferences associated with the mobile device 160 to the organization for electronic commerce in order to customize the promotional content.

Providing location-based promotional content to the mobile device 160 can create a significant opportunity for a commerce transaction or another type of transaction between the mobile device 160 (or another user device, such as mobile device 770) and an electronic commerce device. As such, in one implementation, the commerce agent system 710 can select the organization for electronic commerce that can communicate with the mobile device 160 or related user devices. Such a selection or determination can be performed in numerous ways. In one example, the commerce agent system 710 can permit at least one of the organization platform 750 to subscribe to a communication service. Subscribed organization platform(s) can be provided with an estimate of the current location of the mobile device 160 (or another user device), and can be permitted to provide location-based promotional content directed to the mobile device (or the other user device). In certain implementations, the commerce agent system 710 can retain subscription information within the organization information 734. In another example, the commerce agent system 710 can access at least a portion of the transactional information 746 and can determine transactions (contemporaneous and/or historical) associated with the mobile device 160 (or the mobile device 770). Based at least on such transactions, the commerce agent system 710 can determine an association between an electronic commerce device and the mobile device 160—e.g., a pattern of transactions between the user equipment and the electronic commerce device can be determined; a pattern of types of transactions can be determined and an electronic commerce device that can perform or otherwise facilitate such a type of transactions can be selected or otherwise identified; or the like. In addition, the commerce agent system 710 can test or otherwise determine if such an electronic commerce device has a valid subscription to such a communication service, and in response to a positive determination, the commerce agent system 710 can select the electronic commerce device to be provided with the estimate of the current location of the mobile device 160. In the example embodiment shown in FIG. 8, a commercial component 824 can determine or otherwise select an organization platform for electronic commerce based on such subscription information. A location acquisition component 850 can send location requests (e.g., location request 112) to the location monitoring system 120 in order to obtain an estimate of a current location of a user device in accordance with this disclosure. Transmission of location information indicative of a current location of a user device in exchange for promotional content can be performed at defined times or nearly continuously during the term of a social event or another type of event in accordance with this disclosure. In the example embodiment shown in FIG. 8, a bus 875 can permit the exchange of information between two or more of the functional elements included in the commerce agent system 710. In certain implementations, the bus 875 can be embodied in or can include a system bus, a memory bus, a control bus, a combination thereof, or any other type of bus architecture for the exchange of information. In addition or in other implementations, the bus 875 can permit wireless communication (e.g., optically switched communication), wireline communication, or a combination of both.

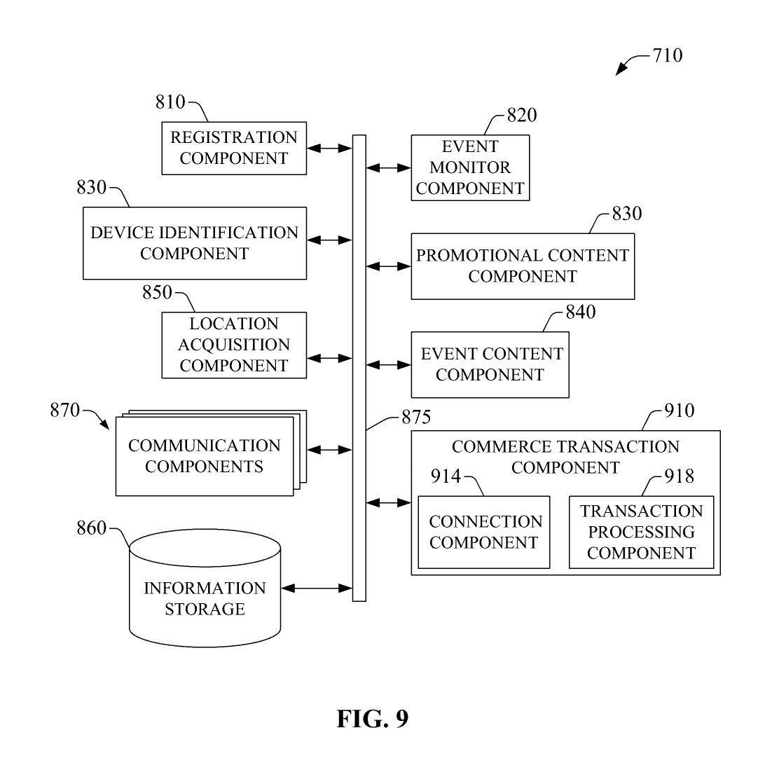

In certain embodiments, the commerce agent system 710 can permit or otherwise facilitate commerce transactions between one of the organization platforms 750 and a device of the group of devices that can receive commerce information and/or location information. FIG. 9 presents an example of such embodiments. As illustrated, the commerce agent system 710 can include a commerce transaction component 910 that can permit such a device (e.g., mobile device 710) to establish a communication session with the commerce agent system 710. The communication session can be secure and can permit exchange of transaction information—e.g., product information, order information, personal information, financial information, of the like—between an organization platform device (e.g., a server of a vendor) and the device. The transaction information can permit or otherwise facilitate, for example, acquisition (via a purchase, for example) of a product or service. For another example, the transaction information can include information that can permit or otherwise facilitate changing an operational state of a device (user device, network device, or the like). The operational state of the device can be associated with a defined configuration of the device and a particular manner of operation of the device in such a configuration (e.g., the device can access certain network resources, computing resources, storage resources, and/or other type of resources). The communication session can be secured by standard and/or proprietary cryptography means. A connection component 914 can initiate and maintain the secured communication session. Tunneling protocols and/or information associated with mechanisms to initiate and/or maintain a secure the communication session can be retained in the information storage 860.

The commerce transaction component 910 also can include a transaction processing component 918 that performs a number of operations related to a commerce transaction between an organization platform and a device of the group of devices. The operations can be performed as a service to the organization platform and can include processing of payments for goods or services in an order, management of delivery information and/or return of goods, processing of claims related to unsatisfactory products or services, and the like. The operation can utilize transaction information received at the commerce agent system 710 within the communication session associated with the commerce transaction. Information to perform such operations and/or information resulting from such operations can be stored at the information storage 860.

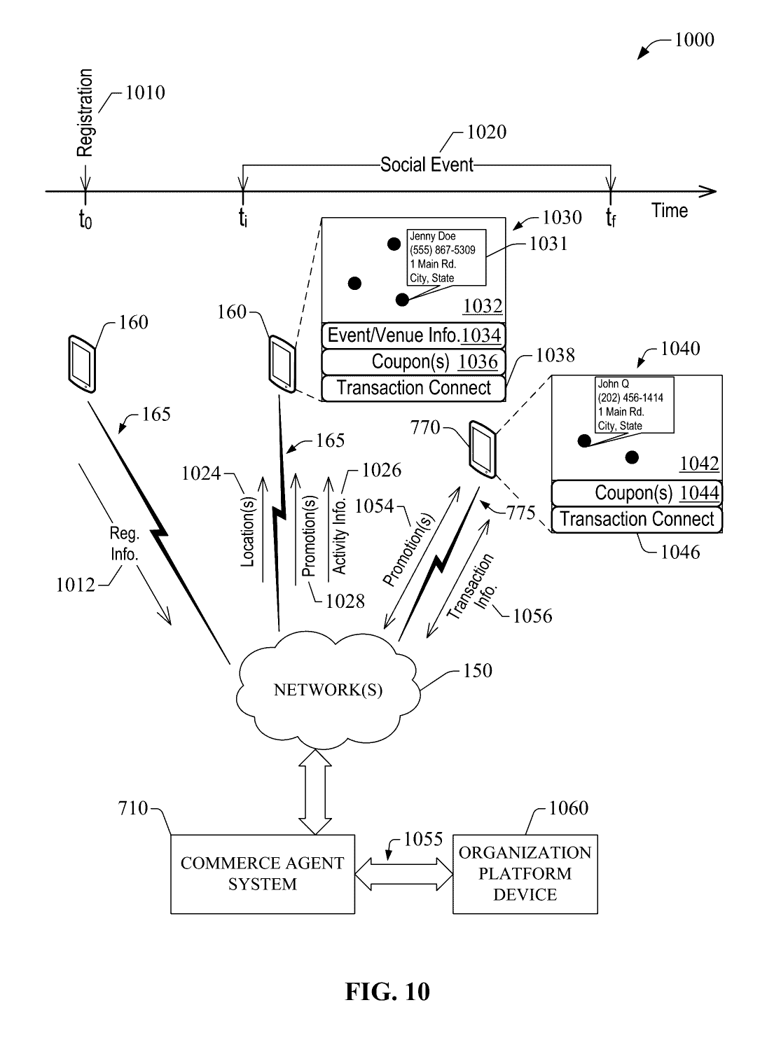

FIG. 10 presents an example of an operational environment 1000 in which commerce, location, and transaction information can be distributed to devices in accordance with one or more embodiments described herein. The distribution of information can be implemented in accordance with aspects described herein and is illustrated with reference to mobile device 160 and mobile device 770. At a certain initial time, represented as t₀, registration of the mobile device 160 with the commerce agent system 710 can be performed. As illustrated, registration can be performed by the mobile device 160. Therefore, in one example, the mobile device 160 can include the configuration client device 760, which can send registration information 1012 to the commerce agent system 710. The registration information 1012 can be sent via one or more network(s) 150, which can include the access network 150 and network devices, such as communication components 720, communication components 124, a combination thereof, or the like, that can permit delivery and/or reception of at least a portion of the registration information 1012. The registration information 1012 can include identifying information of the mobile device and/or opt-in information indicative or otherwise representative of agreement to receive commerce information and/or location information in accordance with aspects of this disclosure. The identifying information can include a communication address, a password or other types of credentials, a combination thereof, or the like.

After registration 1020, a social event 1020 can start at first time tᵢ. The social event 1020 can be a qualified event for a user equipment having a relationship with the mobile device 160. A qualification criterion can be provided at the time of registration 1020. As such, after tᵢ, the commerce agent system 710 can send location information 1024 (referred to as location(s) 1024) indicative or otherwise representative of the user equipment in accordance with aspects of this disclosure. In addition or as an alternative, the commerce agent system 710 can send promotional content 1028 (referred to as promotion(s) 1028) indicative or otherwise representative of advertisements, coupons or other incentivation deals, and/or other type of promotional media associated with an organization platform 1060. Further or as another alternative, the commerce agent system 710 can send activity information 1026 including event information and/or venue information as described herein. The location(s) 1024, promotion(s) 1028, and activity information 1026 can be sent in respective messages (e.g., SMS messages or MMS messages) or in a single message. A message having location(s) 1024, promotion(s) 1028, and/or activity information 1026 can be consumed (e.g., displayed) at the mobile device 160 via, for example, a software application germane to an operating system of the mobile device 160. In one example, the message can be displayed as user interface (UI) 1030 that can include a viewing screen 1032 and selectable indicia. The viewing screen 1032 can include selectable or otherwise actionable indicia (represented as solid dots) representative of respective positions of devices related to the mobile device 160. In one example scenario, the social event 1020 can be a professional conference (e.g., International CES) and the commerce agent system can determine a group of three devices associated with respective colleagues of an end-user of the mobile device 160. The three devices can be determined to be participating in the social event 1020 and, thus, the commerce agent system can send location information associated with the each of the group of devices within location(s) 1024. As such, each of the selectable indicia shown in the viewing screen 1032 can be respectively associated with the group of devices. Selection of displayed selectable indicia in the viewing screen 1032 can cause the mobile device 160 to display indicia 1038 indicative of information associated with an end-user of the device represented by such indicia. To such an end, in one example, the mobile device 160 can include computer-accessible instructions (e.g., computer-readable and/or computer-executable instructions) that, in response to execution by the mobile device 160 (or a processor therein or functionally coupled thereto), can result in the indicia 1038 being displayed. It should be appreciated that other computer-accessible instructions can be executed and, in response to selection of the selectable indicia can cause the mobile device 160 to execute the computer-accessible instructions that result in the displayed indicia. In one embodiment, the mobile device 160 can include a computer-readable storage device (e.g., a memory device) that can include the foregoing computer-accessible instructions, which in one example, can be retained as a program module or another type of software application. The mobile device 160 also can include one or more processors that can execute such computer-accessible instructions, and a display device and/or other input/output device(s) that can display or otherwise present indicia in accordance with aspects of this disclosure.

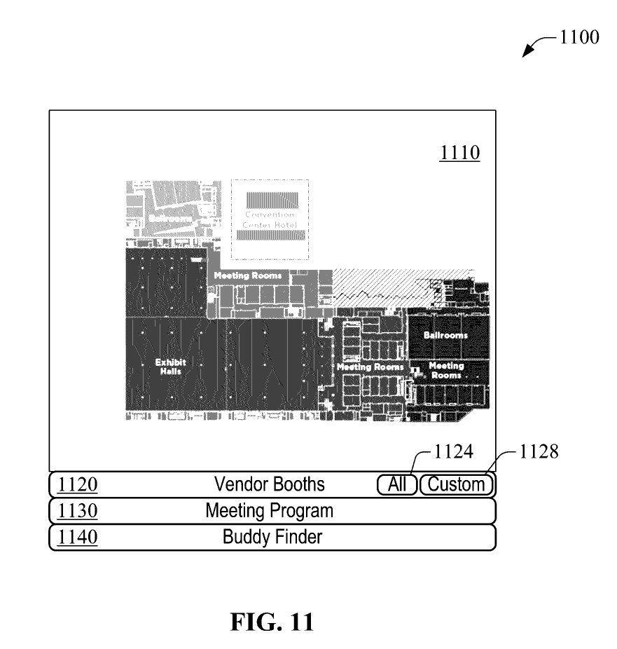

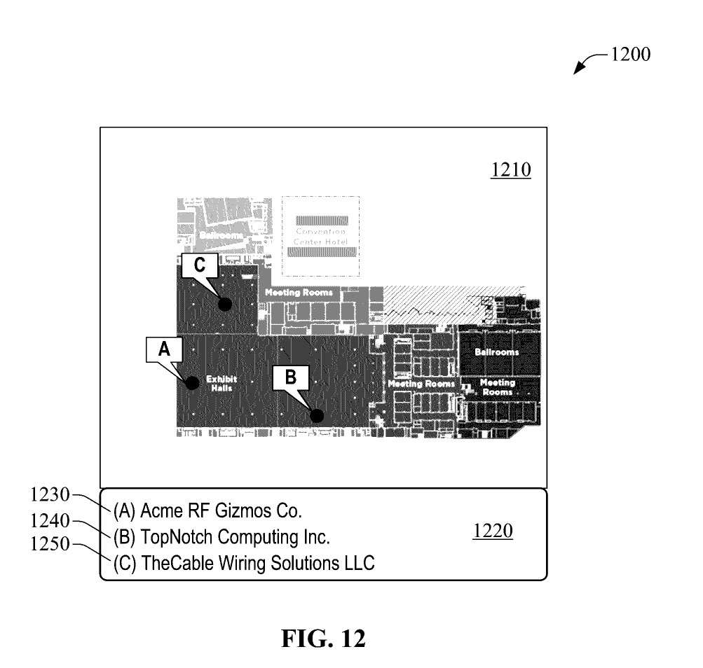

The other actionable indicia displayed in the UI 1030 can include selectable indicia 1034 (labeled as “Event/Venue Info.”) that, in response to selection, can cause the mobile device 160 to present information related to the social event 1020. For instance, the selectable indicia 1034 can be embodied in or can include a visual representation of a selectable hyperlink. To such an end, in one example, the mobile device 160 can include computer-accessible instructions that, in response to execution by the mobile device 160 (or a processor therein or functionally coupled thereto), can result in such information being presented or otherwise displayed. As described herein, it should be appreciated that other computer-accessible instructions can be executed and, in response to selection of the selectable indicia 1034 can cause the mobile device 160 to execute the computer-accessible instructions that result in the presented or otherwise displayed information. A computer-readable storage device (e.g., a memory device) that can retain the foregoing computer-accessible instructions as described herein. As an illustration, FIG. 11 presents an example UI 1100 that can be displayed by the mobile device 160 in response to selection of the selectable indicia 1034. Selection of the selectable indicia 1034 can be achieved via a click, a touch, a pressure swipe, or other types of user-device interaction with the mobile device 160. As illustrated, the UI 1100 can include a viewing pane 1110 that can present an image representing a venue of the social event (e.g., a convention center in which the professional conference takes place). The UI 1100 also can include indicia 1120 (labeled “Vendor Booths”) including selectable indicia 1124 and selectable indicia 1128. Selection of the selectable indicia 1124 can cause the mobile device 160 to display, in the viewing pane 1110, graphical markings representative of respective locations in the venue of all vendors participating in the social event 1020. In contrast, selection of the selectable indicia 1128 can cause the mobile device 160 to display graphical markings representative of respective locations, within the venue, of specific vendors. The specific vendors can be preferred or otherwise of interest to an end-user of the mobile device 160. The specific vendors can be disclosed to the commerce agent system 710 in advance of the social event 1020, or can be determined autonomously by the commerce agent system 710. The specific vendors can be disclosed as part of the registration 1020. As another illustration, FIG. 12 presents an example UI 1200 that can be displayed by the mobile device 160 in response to selection of the selectable indicia 1128. Location of each of the group of specific vendors can be represented with graphical markings in a viewing pane 1210 that displays a floor plan or other type of image representative of the layout of the venue of the social event 1020. The UI 1200 also can include a viewing pane 1220 in which indicia 1230-1250 can identify each of the group of specific vendors.

Continuing with FIG. 11, the UI 1110 also can include selectable indicia 1130 (labeled “Meeting Program”) that, in response to actuation, can cause the mobile device 160 to display a program of activities for the social event 1130. In one implementation, the selectable indicia 1130 can be embodied in a selectable hyperlink that, in response to selection, can be executed in a web browser available to the mobile device 160, causing the mobile device 160 to display the program of activities. In addition, the UI 1110 can include selectable indicia 1140 (labeled “Buddy Finder”) that, in response to selection, can cause the mobile device to display a listing of devices associated with friends and/or family members within or in proximity to the venue of the social event 120. For a device within the venue, the mobile device also can display in the viewing pane 1110 a graphical marking representative of the device's location. As described herein, the mobile device 160 can include computer-accessible instructions that, in response to execution by the mobile device 160 (or a processor therein or functionally coupled thereto), can result in the described information being presented or otherwise displayed at the mobile device 160. As further described herein, a computer-readable storage device (e.g., a memory device) that can retain the foregoing computer-accessible instructions.

With further reference to FIG. 10, the UI 1030 also can include selectable indicia 1036 (labeled “Coupon(s)”) which can include graphical markings or other types of media representative of promotional content available to the mobile device 160. The selectable indicia 1036 also can include selectable indicia 1038 (labeled “Transaction Connect”) that can be associated with particular promotional content (e.g., a coupon or an offer for sale of a product). In response to selection of the selectable indicia 1038, the mobile device 160 can initiate a secure communication session and can permit or otherwise facilitate a commerce transaction or another type of transaction between the mobile device 160 and an organization platform device 1060. As described herein, the mobile device 160 can include computer-accessible instructions that, in response to execution by the mobile device 160 (or a processor therein or functionally coupled thereto), can result in a transaction (commerce transaction or otherwise) being initiated. A computer-readable storage device (e.g., a memory device) that can retain the foregoing computer-accessible instructions.

In addition, in accordance with aspects of this disclosure, the commerce agent system 710 also can distribute location information and/or commerce information to mobile devices having a social networking association with the mobile device 160. As an example, the commerce agent system 710 can send promotional content 1054 (referred to as promotion(s) 1054) indicative or otherwise representative of advertisements, coupons or other incentivation deals, and/or other type of promotional media associated with an organization platform device 1060. While not shown, the commerce agent system 710 also can send location information to the mobile device 770. The location information, the promotion(s) 1054 can be sent at any time or at a series of times (periodically or otherwise) during the duration of the social event 1020. In addition, the location information and/or the promotion(s) 1054 can be sent in respective messages (e.g., SMS messages or MMS messages) or in a single message. A message having location information, promotion(s) 1054, and/or activity information (e.g., venue information and event information other than the venue information) can be consumed (e.g., displayed) at the mobile device 770 via, for example, a software application germane to an operating system of the mobile device 160. It should be appreciated that a specialty software application also can be utilized to such an end. In one example, the message can be displayed as UI 1040 that can include a viewing screen 1042 and selectable indicia. Specifically, in one example, the viewing screen 1042 can include selectable or otherwise actionable indicia (represented as solid dots) representative of respective positions of devices related to the mobile device 770 (e.g., location of the mobile device 160). As described herein, selection of a displayed selectable indicia in the viewing screen 1042 can direct (e.g., send an instruction to) the mobile device 770 to display graphical markings or other type of media indicative of information associated with an end-user of the device represented by such selectable indicia.

Indicia 1044 (labeled “Coupon(s)”) also can be displayed within the UI 1040. Similar to indicia 1036, the indicia 1044 can include selectable indicia 1046 (labeled “Transaction Connect”) that, in response to selection, can direct or otherwise cause the mobile device 770 to engage in commerce transaction with the organization platform device 1060. Therefore, the mobile device 770 can send transaction information 1056 (data, metadata, and/or signaling) associated with the commerce transaction, including session information related to establishment of a secure communication session with the commerce agent system 770 and implementation information related to performance of the commerce transaction. Similar to the mobile device 160, the mobile device 770 can include computer-accessible instructions that, in response to execution by the mobile device 770 (or a processor therein or functionally coupled thereto), can result in the foregoing display functionality and/or processing functionality of the mobile device 770.

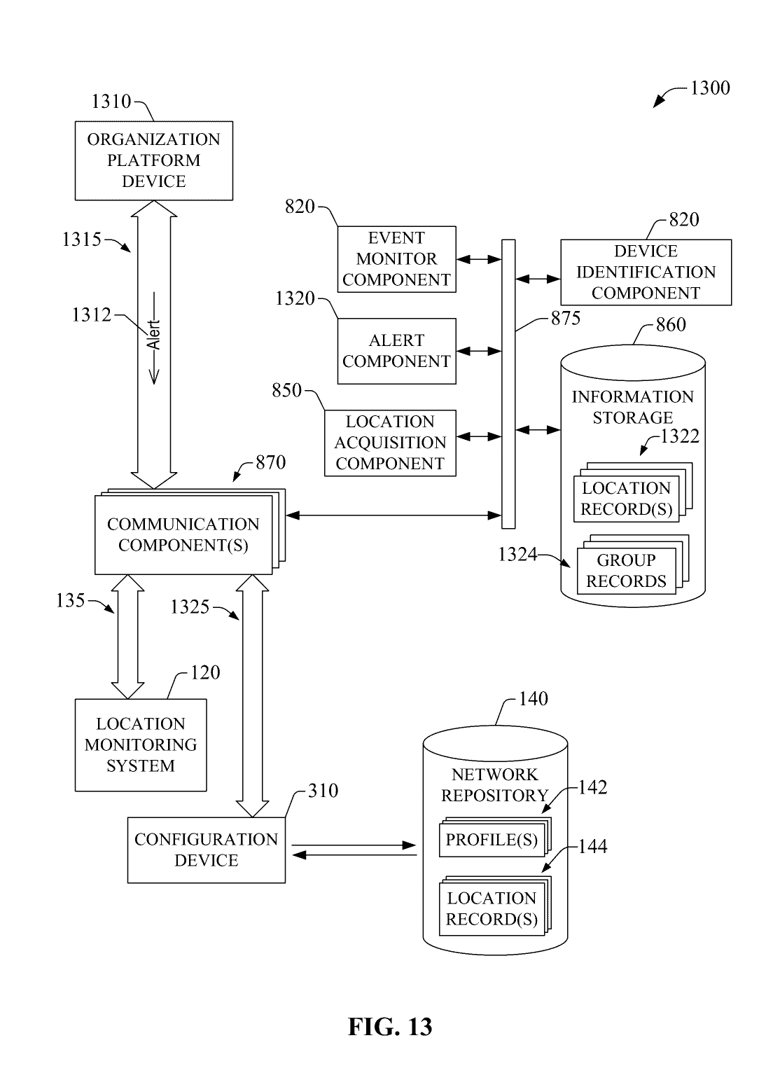

As described herein, the commerce agent system 710 can determine relationship relevancy of a device and can rely upon the relationship relevancy to determine if communication of location information of a mobile device is appropriate or otherwise warranted. Such a determination in combination with the override configuration of an authorization configuration as described herein can permit or otherwise facilitate distribution of the location information in response to a distribution criterion being satisfied. FIG. 13 presents an example of an operational environment 1300 for distribution of location information in response to distribution criteria and/or other rules for distribution of such information. As illustrated, an organization platform device 1310 can send (e.g., push or otherwise transmit) an alert 1312 to a communication component (e.g., a gateway device) of the communications devices 870 of a commerce agent system. The alert 1312 can be associated with a condition or state of a mobile device (e.g., mobile device 160) and, thus, can include information indicative of a communication address of the mobile device. The organization platform device 1310 can be functionally coupled to the communication component via communication links 1315. In one embodiment, the organization platform device 1310 can embodied in or can constitute a server deployed within one of the organization platforms 750, such as a platform for law enforcement. As such, the alert 1312 can be or can include, for example, an AMBER Alert or a Silver Alert, and can be sent by the organization platform device 1310 in response to the activation of such an alert.

Regardless of the specific type alert, the commerce agent system can include event monitor component 820, which can receive the alert 1312 and, in response, can establish the initiation of a qualified event and can begin monitoring for signaling or other type of information indicative or otherwise representative of termination of the alert 1312 (e.g., deactivation of an AMBER Alert or a Silver Alert). The event monitor component 820 can continue monitoring for information related to termination of the alert 1312 concurrently or nearly concurrently with other operations of the commerce agent system. In addition, as another response to the alert 1312, the event monitor component 820 can direct an alert component 1320 of the commerce agent system to cause an update of a device profile of a mobile device associated with the alert 1312. The device profile can be updated to include an authorization configuration having opt-in information indicative or otherwise representative of permission to track location of the mobile device. To that end, in one implementation, the alert component 1320 can receive one directive to update the device profile of the mobile device from the event monitor component 820. In response, the alert component 1320 can send a second directive to the configuration device 310 to perform such an update. The second directive can be sent to the configuration device via one or more communication components (e.g., a router and/or a gateway device) of the communication component(s) 870 and communication links 1325. The updated device profile can be retained within the profile(s) 142 in the network repository 140.

The commerce agent system also can include location acquisition component 850, which can cause the location monitoring system 120 to provide an estimate of a current location of the mobile device associated with the alert 1312. For instance, in accordance with embodiments described herein, the location acquisition component 850 can query the location monitoring system by sending a location request (e.g., location request 112). The opt-in information included in the updated device profile of the mobile device can permit location monitoring system 120 to determine such an estimate in accordance with aspects of this disclosure. Thus, the location monitoring system 120 can fulfill the location request received from the location acquisition component 850, and can send a message (e.g., current location message 116) including the estimate to the location acquisition component 850. Information indicative of the estimate of the current location of the mobile device can be stored in one or more memory elements 1322 in the information storage 860.

In addition, the commerce agent system that receives the alert 1312 also can include device identification component 820, which can determine a group of devices to which location information associated with the mobile device can be or is to be delivered. The group of devices can be determined in accordance with aspects described herein, and can include a device associated with law enforcement; another device associated with first responders or a search-and-rescue team; yet another device associated with a parent of an end-user of the mobile device, a device associated with a physician of the end-user, a combination thereof, or the like. It can be appreciates that group of devices can include devices that can benefit from being aware of the current location of the mobile device. A device included in the group of devices can be mobile or tethered. Device information indicative or otherwise representative of the group of devices can be stored in one or more memory elements 1324 of the information storage 860. For example, respective communication addresses (telephone number, IMSI, MAC address, IP address, or the like) of the group of devices can be stored in the memory element(s) 1324 in the information storage 860.

The commerce agent system that receives the alert 1312 can send, via the alert component 1320, for example, information indicative of the estimate of the current location of the mobile device to one or more devices in the group of devices determined by the device identification component 820. To that end, in certain implementations, the alert component 1320 can send respective messages to the group of devices via communication components included in the location monitoring system 120 and network device(s) in an access network to which the devices in the group of devices are coupled. As described herein, such messages can be embodied in or can constitute, for example, SMS messages, MMS messages, email messages, a combination thereof, or the like. In certain embodiments, the alert 1312 can include communication addresses of recipient devices (e.g., a first responder device or a police device) to which the estimate of the current location of the mobile device is to be sent, and the alert component 1320 can send a message to a communication address of one of such recipient devices.

The commerce agent system that receives the alert 1312 can continue to notify the group of device of a current location of the mobile device associated with the alert 1312 while the same is active. Upon or after the event monitor component 820 determines that the alert 1312 is inactive, or that event associated with the alert 1312 has terminated, the event monitor component 820 can cause the alert component 1320 to terminate distribution of location information indicative of the current location of such a mobile device. In addition or in other embodiments, in response to terminating distribution of the location information, the alert component 1320 can cause the configuration device 310 to restore the device profile of the mobile device to a configuration prior to the alert 1312.

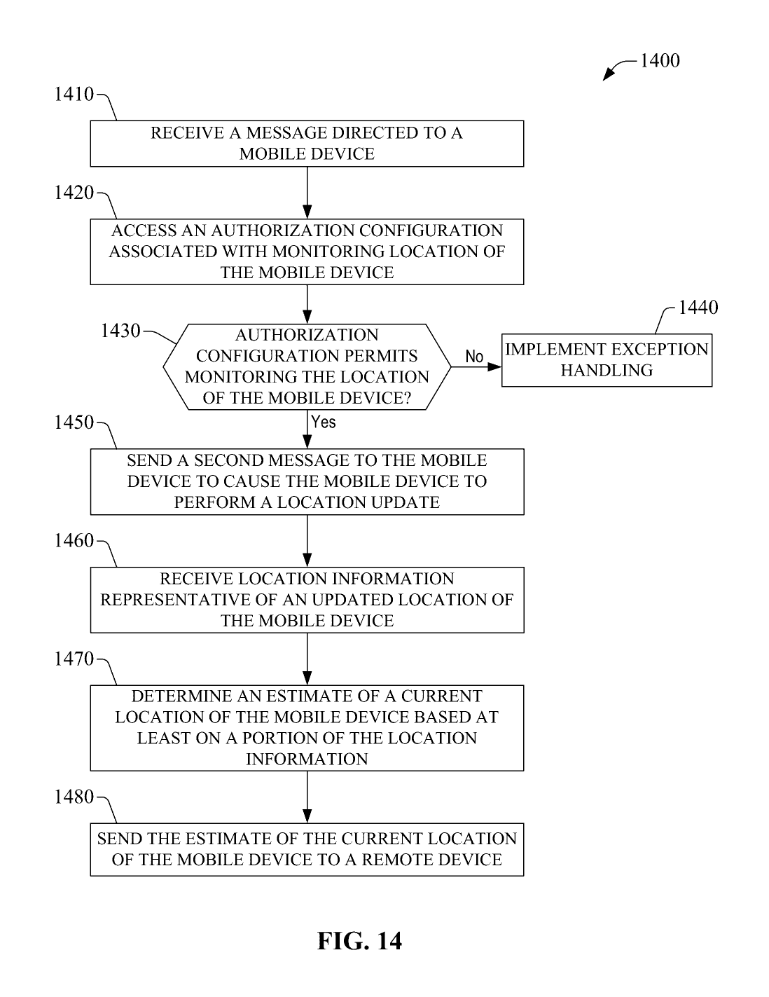

In view of the aspects described herein, an example method that can be implemented in accordance with this disclosure can be better appreciated with reference to FIGS. 14-18. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, one or more example methods disclosed herein can alternatively be represented as a series of interrelated states or events, such as in a state diagram. Moreover, interaction diagram(s) may represent methods in accordance with the disclosed subject matter when disparate entities enact disparate portions of the methodologies. Furthermore, not all illustrated acts may be required to implement a described example method in accordance with the subject specification. Further yet, two or more of the disclosed example methods can be implemented in combination with each other, to accomplish one or more features or advantages described herein. It should be further appreciated that the example methods disclosed throughout the subject specification are capable of being stored on an article of manufacture to facilitate transporting and transferring such example methods to computers for execution, and thus implementation, by a processor or for storage in a memory.

Methods disclosed throughout the subject specification and annexed drawings are capable of being stored on an article of manufacture to facilitate transporting and transferring such methodologies to computers for execution, and thus implementation, by a processor or for storage in a memory. In an aspect, one or more processors that enact method(s) described herein can be employed to execute code instructions retained in a memory, or any computer- or machine-readable medium, to implement method(s) described herein; the code instructions, when executed by the one or more processor implement or carry out the various acts in the method(s) described herein. The code instructions provide a computer- or machine-executable framework to enact the method(s) described herein.

FIG. 14 presents a flowchart of an example method 1400 for determining location of a mobile device in accordance with one or more embodiments of the disclosure. The example method can be implemented, entirely or in part, by a computing system having processors, memory devices, and/or other computing resources. In certain embodiments, the computing system can be embodied in or can include the location monitoring system 120 described herein in connection with FIG. 1. At block 1410, a message directed to a mobile device (e.g., mobile device 160) can be received by the computing system. The message can convey a request for an estimate of a current location of the mobile device, and can be embodied in or can include, for example, a SMS message, an MMS message, a SIP INVITE message, a USDD message, or the like. A communication component (e.g., a web-based gateway) of the computing system can receive the message. In certain implementations, the component can be embodied in or can include a web-based gateway device. In other implementations, the component can be embodied in or can include a mobile switching center (MSC) device. As described herein, the message can be originated at or otherwise provided by a remote device deployed within a first network (e.g., represented as “Network A” in FIG. 1) that is different from a second network (e.g., represented as “Network B” in FIG. 1) that provides wireless service or other services to the mobile device. The first network can embody or can include a platform for electronic commerce or a platform for law enforcement.

At block 1420, an authorization configuration associated with monitoring location of the mobile device can be accessed by the computing system. As described herein, the authorization configuration can be retained or otherwise recorded within a profile of the mobile device, and can include information (e.g., opt-in information or opt-out information) indicative or otherwise representative of permission or lack thereof to monitor the location of the mobile device. It should be appreciated that, as described herein, the authorization configuration is accessed in response to the message received by the computing system at block 1410. In addition, in certain embodiments, the authorization configuration can be preconfigured or otherwise predetermined prior to reception of such a message and without operation of the mobile device to such an end.

At block 1430, the computing system can determine if the authorization configuration permits monitoring the location of the mobile device. To that end, the computing system can determine if the authorization configuration includes opt-in information that conveys permission to monitor the location of the mobile device. As described herein, the opt-in information also can specify scope of the permission to monitor the location of the mobile device, e.g., period during which location can be monitored, devices permitted to monitor the location of the mobile device, conditions or events under which location of the mobile device can be monitored, a combination thereof, or the like. In a scenario in which it is ascertained that the authorization configuration does not include opt-in information or includes opt-out information specifying that monitoring of the location of the mobile device is not permitted (“No” branch), the computing system can implement exception handling at block 1440. As described herein, in one example, implementing the exception handling can result in rejection of the request conveyed in the message received at block 1410. In the alternative, in a scenario in which it is ascertained that the authorization configuration includes opt-in information that authorizes monitoring the location of the mobile device, the computing system can send a second message to the mobile device at block 1450. The second message can cause the mobile device to perform a location update. In certain embodiments, the second message can be embodied in a control message within a standardized protocol for generation of a location update of the mobile device, such a location area update (LAU) in UMTS or a location determination procedure in E-911.

At block 1460, location information representative of an updated location of the mobile device can be received by the computing system. The location information can be received by a component (e.g., location component 132) of the computing system that is configured to determine and/or update a current location of the mobile device. At block 1470, an estimate of the current location of the mobile device can be determined, by the computing system, based at least on a portion of the location information.

At block 1480, the estimate of the current location of the mobile device can be sent, by the computing system, to a remote device. For example, the remote device can be embodied in or can include the location requestor device 110. As described herein, a communication component (e.g., a web-based gateway device or a MSC device) of the computing system can send the estimate of the current location to the remote device. In certain implementations, as described herein, the remote device can be deployed (e.g., installed, configured, and accepted) at a platform for electronic commerce. In other implementations, as described herein, the remote device can be deployed at a platform for law enforcement.

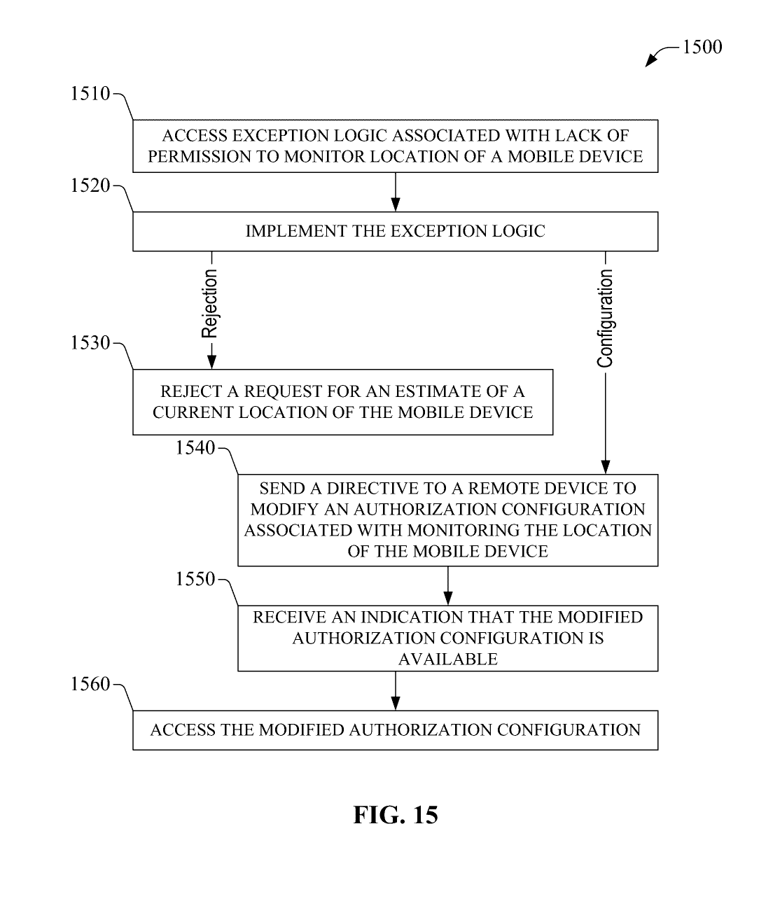

FIG. 15 presents a flowchart of an example method 1500 for exception handling in connection with determining location of mobile devices in accordance with one or more embodiments of the disclosure. The example method can be implemented, entirely or in part, by a computing system having processors, memory devices, and/or other computing resources. In certain embodiments, the computing system can be embodied in or can include the location monitoring system 120 described herein in connection with FIG. 1. More specifically, in one of such embodiments, the location access component 128 can implement the example method.

At block 1510, exception logic associated with lack of permission to monitor location of a mobile device can be accessed by the computing system. The exception logic can be accessed, for example, in response to an authorization configuration having opt-out information that specifies that location of the mobile device is not to be tracked. At block 1520, the exception logic can be implemented. In one embodiment, the location access component 128 in the location monitoring system 120 can access the exception logic and can implement it.

Various outcomes are possible in response to implementation of the exception logic. As illustrated, one outcome can include rejection of a request for an estimate of a current location of the mobile device. As such, at block 1530, the request for the estimate of the current location of the mobile device can be rejected. Rejecting such a request can include sending a message to the a remote device that originated the request. The message can be embodied in a SMS message, a MMS message, a simple network management protocol (SNMP) message, or the like. A second outcome can include configuration of the authorization configuration including the opt-out information that caused the exception. Such an outcome (“Configuration” in FIG. 15) can result in several operations. For example, at block 1540, the computing system can send a directive to modify the authorization configuration to a remote device (e.g., configuration device 310). In addition, at block, 1550 the computing system can receive an indication that a modified authorization configuration is available (e.g., stored in a device profile associated with the mobile device). As described herein, the modified authorization configuration can include opt-in information representative or otherwise indicative of permission to monitor the location of the mobile device.

The method 1500 can contemplate retrying access to authorization configurations after a modification is implemented in response to the accessed exception logic. Thus, at block 1560, the modified authorization configuration can be accessed.

It can be appreciated that humans are incapable of performing all of the blocks of the methods 1400 and 1500. Therefore, the various aspects of method 1400 and method 1500 cannot be mere implementations of human activities nor as disembodied, mental or abstract operations or embodiments. For example, the method 1400 includes wireless exchange of messages over a wireless and/or a non-wireless network. In another example, the method 1400 includes determination of an estimate of location of a mobile device using location information received wirelessly. The wireless reception of the location information alone conveys that a human relying on mental operations or mere pen and paper cannot implement at least such a determination block simply because information received wirelessly generally is demodulated and/or decoded according to a complex modulation and coding scheme. Thus, it is readily apparent that humans cannot perform at least the determination of the estimate of the current location of the mobile device that is described herein.

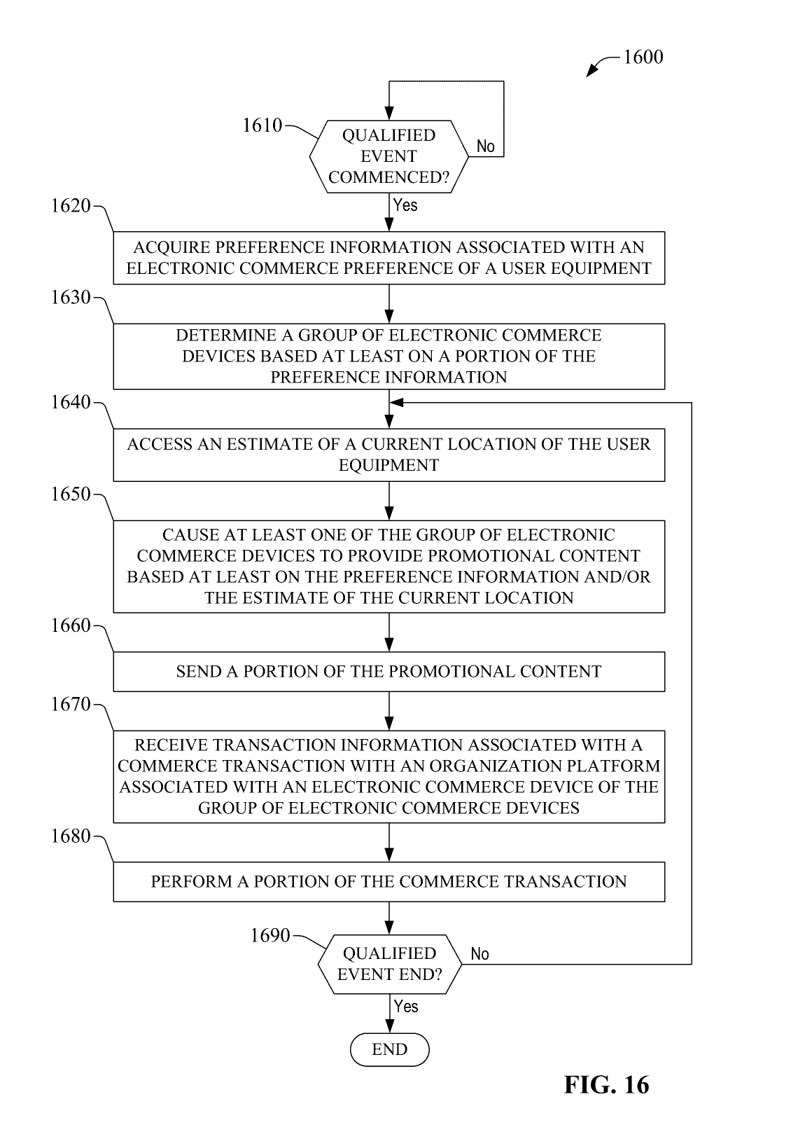

FIG. 16 presents a flowchart of an example method 1600 for conducting commerce transactions in accordance with one or more embodiments of the disclosure. The example method can be implemented, entirely or in part, by a computing system having processors, memory devices, and/or other computing resources. In certain embodiments, the computing system can be embodied in or can include the commerce agent system 710 described herein with respect to FIG. 7. At block 1610, the computing system can determined if a qualified event commenced. To that end, in certain implementations, the computing system can monitor social networking information and/or transactional information to identify an event, and can determine if the event satisfies a qualification criterion (e.g., the event is associated with specific mobile devices, the event has been selected by a mobile device, the event is a social event of a defined type, or the like). It should be appreciated that, as described herein, the qualified event can be a social event or another type of event (e.g., an emergency alert or the like). In response to the event satisfying the qualification criterion, the event is identified as a qualified event and the computing system can determine if a current time (e.g., a date, or a time of day on a certain day) coincides or is past a starting date or time of the qualified event. When the current time fails to coincide with such a starting date or time, the computing system can ascertain that the qualified event has not commenced. In the alternative, the computing system can ascertain that the qualified event commenced. As described herein, in certain embodiments, the qualified event can be or can include a social event. In addition or in other embodiments, the computing system can apply or otherwise utilize other triggers associated with the qualified event besides commencement of the qualified event. Such triggers can include a time-based trigger, such as a criterion for activity related to the qualified event. Specifically, for example, the criterion can be embodied in a threshold relative to commencement of the qualified event—e.g., the computing system can determine that the qualified event can commence within a defined time interval (e.g., 30 minutes) or at a defined time of day. In addition or in the alternative, the triggers can include a non-time-based trigger, such as a criterion related to inception of the qualified event (e.g., scheduling of a social event, confirmation of invited speakers to a conference, and the like).

In response to ascertaining that the qualified event has not commenced (“No” branch), the computing system can continue to probe for commencement of qualified events. In the alternative, in response to ascertaining that the qualified event commenced (“Yes” branch), flow of the example method can continue to block 1620 in which preference information associated with an electronic commerce preference of a user equipment can be acquired or otherwise accessed by the computing system.

At block 1630, a group of electronic commerce devices can be determined or otherwise identified by the computing system based at least on a portion of the preference information. In addition or in other embodiments, the computing system can determine at least one of the group of electronic commerce devices based on transactional information (e.g., transactional information 746). More specifically, as an illustration, the computing system can access at least a portion of the transactional information from a repository and can determine transactions (contemporaneous and/or historical) associated with the user equipment. From the transactional information so determined, the computing system can determine an association between an electronic commerce device and the user equipment—e.g., a pattern of transactions between the user equipment and the electronic commerce device can be determined; a pattern of types of transactions can be determined and an electronic commerce device that can perform or otherwise facilitate such a type of transactions can be selected or otherwise identified; or the like. Regardless of the manner in which electronic commerce devices are selected or otherwise determined, the computing system can filter or otherwise refine such a selection based on a subscription to a communication service that permits communication between an electronic commerce device and the user equipment, as described herein. In certain embodiments, the computing system can select or otherwise determine the group of electronic commerce devices solely on a subscription criterion indicative of a valid subscription to a service that permits exchange of information between an electronic commerce device in such a group and the user equipment. Therefore, at least one of the group of electronic commerce devices can be configured to communicate with the user equipment.

At block 1640, an estimate of a current location of the user equipment can be accessed by the computing system. In certain embodiments, a component of the computing system, such as the location acquisition component 850, can cause a remote system to determine the estimate of the current location of the user equipment. For instance, the component can send a location request (e.g., a location request 112) to the remote system, which in response can provide a message (e.g., a SMS message) including information indicative or otherwise representative of the estimate of the user equipment. The remote system can be embodied in or can include, for example, the location monitoring system 120, and can determine such an estimate in accordance with aspects described herein.

At block 1650, the computing system can cause (e.g., can instruct or otherwise direct) at least one of the group of electronic commerce devices (e.g., network devices associated with organization platforms 750) to provide promotional content based at least on one or more of a portion of the preference information or the estimate of the current location. As described herein, the promotional content can include advertisements, coupons or other incentivation media, and/or other type of promotional media of such an organization platform associated with the electronic commerce device. In certain embodiments, a component of the computing system, e.g. the promotional content component 830, can send a directive (or an instruction) to an electronic commerce device of one of the organization platforms 770, where the directive can cause the electronic commerce device to provide promotional content. The promotional content can be received at the computing system that implements the example method and, at block 1660, a portion of the promotional content can be sent to the user equipment (e.g., mobile device 160 or mobile device). By causing the at least one of the group of electronic commerce devices to provide such content and receiving the same, the computing system can access or otherwise obtain promotional content based at least on one or more of a portion of the preference information or the estimate of the current location. In other embodiments, another computing system functionally coupled to the computing system can instruct the at least one of the group of electronic commerce devices to provide at least a portion of the promotional content. For instance the other computing system can send a request to the at least one of the group of electronic commerce devices to provide at least a portion of the promotional content. The computing system can receive at least the promotional content requested by the other computing system.

In certain embodiments, the promotional content can include transaction information that can be executed at the user equipment to initiate a commerce transaction. An HTTP application, a MAP application, and/or a specialty application can execute the transaction information. In other embodiments, the promotional content can be augmented with such transaction information. In one example, the component of the computing system that receives the promotional content can insert the transaction information into the promotional content. In any instance, in response to the portion of promotional content that is sent at block 1660, the computing system (e.g., commerce agent system 110) can receive transaction information associated with the commerce transaction with the organization platform associated with the electronic commerce device that can provide the promotional content. In addition, at block 1680, a portion of the commerce transaction can be performed by the computing system. Therefore, it can be appreciated that, in at least certain embodiments, the computing system can operate as commerce broker between the user equipment and such an organization.

At block 1690, the computing system can determine if the qualified event ended. It should be appreciated that while block 1690 is shown subsequent to block 1680, implementation of block 1690 can be concurrent or nearly concurrent with other blocks of the example method. In particular, yet not exclusively, block 1690 can be performed concurrently with blocks 1640, 1650, and/or 1660.

It is noted that humans are incapable of performing all of the blocks of the example method 1600. Therefore, the various aspects of the example method 1600 cannot be mere implementations of human activities nor as disembodied, mental or abstract operations or embodiments.

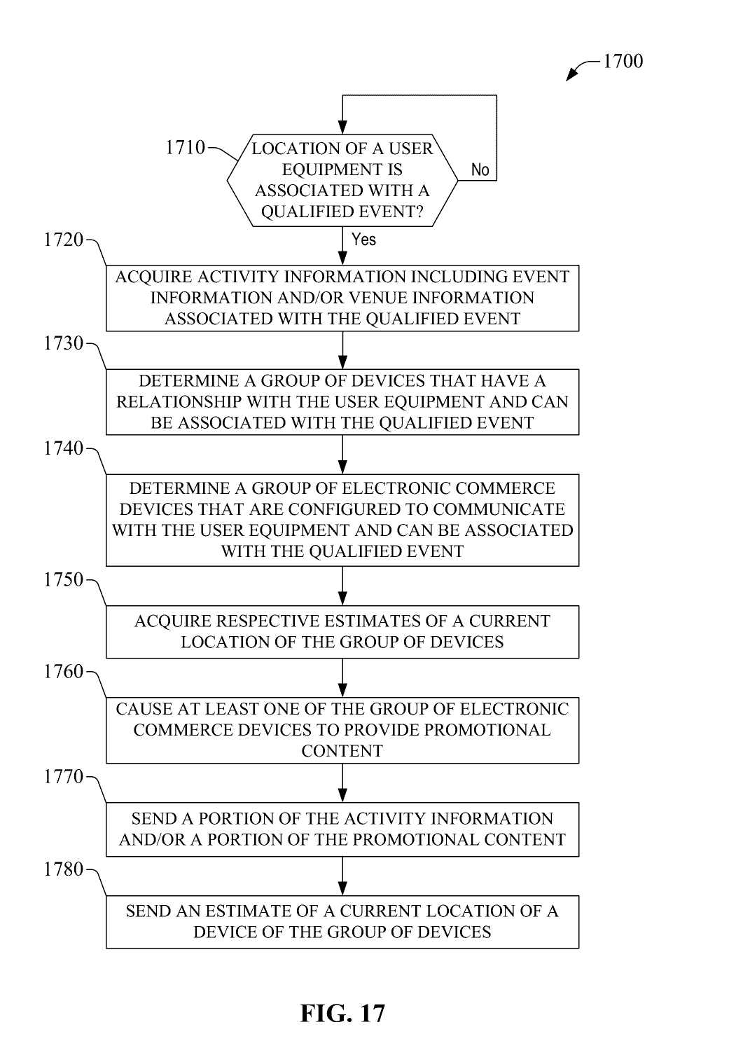

FIG. 17 presents a flowchart of an example method 1700 for distributing commercial information in accordance with one or more embodiments of the disclosure. The example method can be implemented, entirely or in part, by a computing system having processors, memory devices, and/or other computing resources. In certain embodiments, the computing system can be embodied in or can include the commerce agent system 710 described herein in connection with FIG. 7. At block 1710, the computing system can determine if a location of a user equipment is associated with a qualified event. In one implementation, the computing system can determine a current location of the user equipment, and can compare the current location to venue location (e.g., location of a hotel, location of a movie theater, location of a stadium, or the like) associated with the qualified event. In a scenario in which the current location is within a defined distance from the venue location, the computing system can ascertain that the location of the user equipment is associated with the qualified event (e.g., a professional organization meeting). In other embodiments, the computing system can apply another rule or implement another trigger (e.g., time-based trigger and/or non-time-based trigger) as an alternative or in addition to the determination that the location of the user equipment is associated with the qualified event. For example, the computing system can determined if the qualified event is scheduled to commence at a defined time. For another example, the computing system can determine if the user equipment is registered to receive commerce information, other types of transaction information, and/or information associated with the qualified event.

At block 1720, event information and/or venue information associated with the qualified event can be acquired or otherwise accessed by the computing system. The event information can include, for example, a listing of participants in the social event (e.g., vendors, speakers, and the like); a schedule of activities within the social event (e.g., presentations, panels, banquets, and the like); a listing of organizers of the social event; or the like. The venue information can characterize the event's venue, including indoor and/or outdoor landmarks. As described herein, in one embodiment, at least a portion of the event information can be acquired from social network information and/or transactional information retained in a network repository deployed in a network, such as a communication network or a multiple services operator (MSO) network.

At block 1730, the computing system can determine a group of devices that have a relationship with the user equipment and can be associated with the qualified event. One or more of such a group of devices can be determined in accordance with aspects of this disclosure. At block 1740, the computing system can determine a group of electronic commerce devices that are configured to communicate with the user equipment and that can be associated with the qualified event. As described herein, in certain implementations, one or more of the group of electronic commerce devices can be determined based at least on contemporaneous monetary-transactions and/or non-monetary transactions that relate an electronic commerce device to the user equipment. For example, the computing system can utilize (e.g., monitor) or otherwise leverage transactional information 746 and/or commerce preferences 742 in order to determine at least one of the group of electronic commerce devices. At block 1750, respective estimates of a current location of the group of devices can be acquired or otherwise accessed by the computing system. In certain embodiments, a component of the computing system, such as the location acquisition component 850, can cause a remote system to determine an estimate of a current location of a device of the group of devices. For instance, as described herein, the component can send a location request (e.g., a location request 112) to the remote system, which in response can provide a message (e.g., a SMS message) including information indicative or otherwise representative of the estimate of the user equipment. The remote system can be embodied in or can include, for example, the location monitoring system 120, and can determine such an estimate in accordance with aspects described herein.

At block 1760, the computing system can cause at least one of the group of electronic commerce devices to provide promotional content. The promotional content can be generated and/or otherwise selected using a portion of the event information, a portion of the venue information, and/or commerce preferences associated with the user equipment. Other factors can be considered in order to generate or otherwise select the promotional content—an advertisement, a coupon, loyalty program points or other types of reward points, a cash-back award, or the like. A component of the computing system, e.g. the promotional content component 830, can send a directive to an electronic commerce device of one of the organization platforms 770 in order to cause the electronic commerce device to generate or select the promotional content.

At block 1770, a portion of the event information and/or a portion of the promotional content can be sent by the computing system. In one embodiment, such information and/or content can be sent to the user equipment. In certain implementations, one component of the computing system, e.g. the promotional content component 830, can send the portion of the promotional content via, for example, a first communication component (e.g., a gateway device) of the computing system. In addition, a second component can send the portion of the event information via, for example, a second communication component (e.g., another gateway device) of the computing system. It should be appreciated that, in other implementations, that a single communication component can be utilized or otherwise leveraged in order to send the portion of the promotional content and the portion of the event information.

At block 1780, an estimate of a current location of a device of the group of devices can be sent by the computing system. Such an estimate can be sent to the user equipment (e.g., mobile device 160) and/or another device (mobile or otherwise). In certain implementations, as described herein, the computing system can send a message including a hyperlink associated with geographic coordinates indicative of the estimate of the current location of the device of the group of devices. The hyperlink can be configured to be executed by a web application (e.g., a HTTP application or a MAP application) at the user equipment or the other device.

While blocks of the example method 1700 can be implemented in response to the a positive determination that location of the user equipment is associated with the qualified event, it should be appreciated that the disclosure is not limited in this respect and other criteria or rules can be contemplated in order to implement one or more of the described blocks. As described herein, in one embodiment, block(s) of the example method 1700 (such as block 1730) can be implemented in response to a positive determination that the qualified event is scheduled to commence at a later time. In addition or in another embodiment, block(s) of the example method 1700 (such as block 1730) can be implemented in response to a positive determination that the user equipment is registered to receive transaction information (such as information that can facilitate a purchase of a product or service) and/or the activity information.

It is noted that humans are incapable of performing all of the blocks of the example method 1700. Therefore, the various aspects of the example method 1700 cannot be mere implementations of human activities nor as disembodied, mental or abstract operations or embodiments.

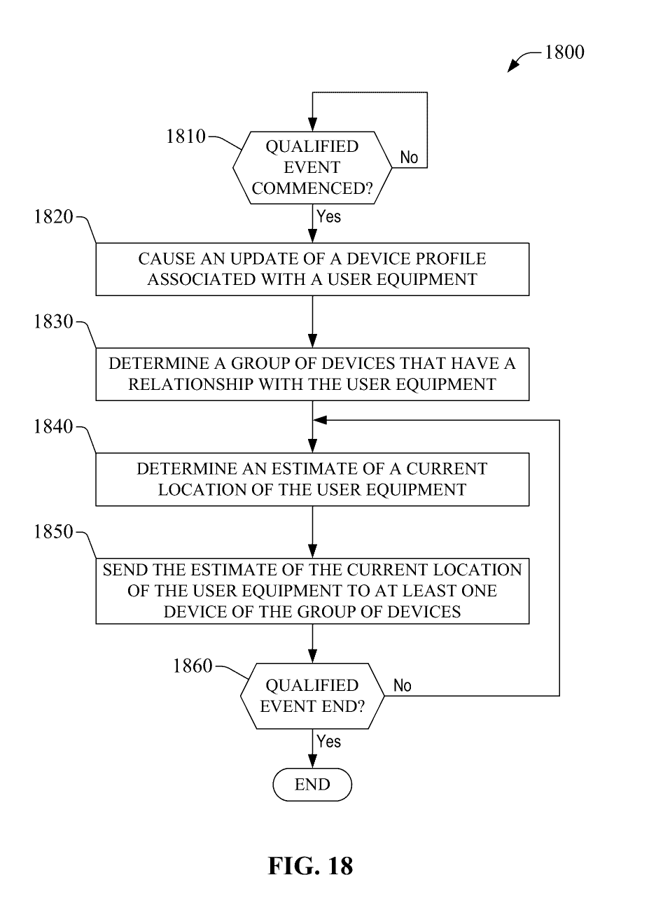

FIG. 18 presents a flowchart of an example method 1800 for distributing location information in accordance with one or more embodiments of the disclosure. The example method can be implemented, entirely or in part, by a computing system having processors, memory devices, and/or other computing resources. In certain embodiments, the computing system can be embodied in or can include the commerce agent system 710 described herein in connection with FIG. 13. At block 1810, the computing system can determine if a qualified event commenced. For instance, the qualified event can be or can include an AMBER Alert or a Silver Alert, and commencement of such an event begins when the AMBER Alert or the Silver Alert is activated. Such a determination can be implemented as described herein in connection with implementation of block 1210 in FIG. 12. In response to ascertaining that the event has not commenced, the computing system can continue to implement block 1810. As described herein, block 1810 can be implemented nearly continuously, periodically, or according to a schedule of defined non-periodic times. More generally, block 1810 can be implemented in response to a specific rule, which can be event-based or time-based. In the alternative, in response to ascertaining that the qualified event commenced (e.g., a conference started at a meeting room or a conference call started in communication bridge device), the computing system can cause an update of a device profile associated with a user equipment at block 1820.

At block 1830, a group of devices that have a relationship with the user equipment can be determined by the computing system. As described herein, a component of the computing system (e.g., the device identification component 820) can determine or otherwise identify at least one device of the group of devices. At block 1840, an estimate of a current location of the user equipment can be acquired by the computing system. For instance, the computing system can include the location acquisition component 850, which can acquire such an estimate in accordance with aspects described herein.

At block 1850, the computing system can send the estimate of the current location of the user equipment (e.g., mobile device 160) to at least one device (e.g., mobile device 780) of the group of devices. Therefore, one or more devices of the group of devices can be notified of the current location of the user equipment. At block 1860, the computing system can determine if the qualified event ended. In a scenario in which the qualified event has not ended (“No” branch), flow of the example method can be directed to block 1840. As such, while the qualified event is ongoing (e.g., the AMBER Alert or the Silver Alert remains active), implementation of this example method can continue to distribute the estimate of the current location of the user equipment to one or more devices of the group of devices. It should be appreciated that while block 1860 is shown subsequent to block 1850, implementation of block 1890 can be concurrent or nearly concurrent with other blocks of the example method. In particular, yet not exclusively, block 1890 can be performed concurrently with blocks 1840, 1850, and/or 1860.

It is noted that humans are incapable of performing all of the blocks of the example method 1800. Therefore, the various aspects of the example method 1800 cannot be mere implementations of human activities nor as disembodied, mental or abstract operations or embodiments.

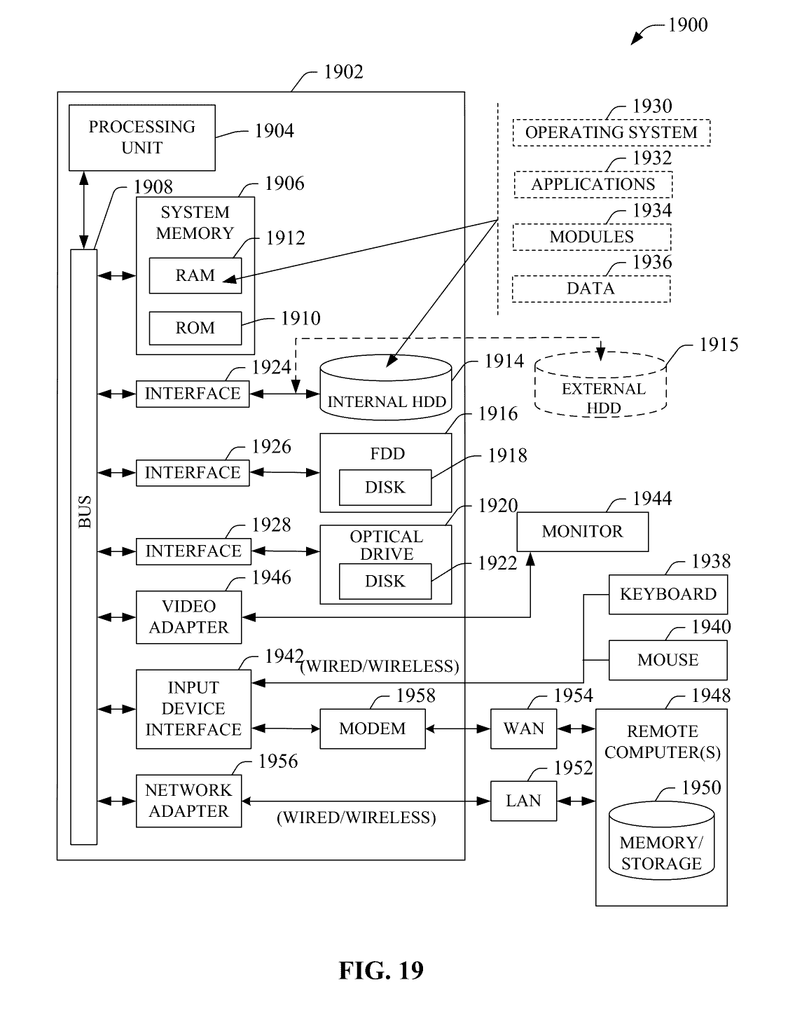

In order to provide additional context for various aspects of this disclosure, FIG. 19 and the following discussion are intended to provide a brief, general description of a suitable example computing environment 1900 in which the various aspects of the specification can be implemented. Example computing environment 1900 can embody several of the devices (network device, user devices, or the like) and/or components described herein. In addition, example computing environment 1900 can execute or otherwise implement components, or portions thereof, implemented as software application(s) or firmware applications(s). Memory elements that are part of computing environment 1900 can embody or can constitute various data stores described in the one or more embodiments of the subject disclosure. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable storage devices. Computer-readable storage devices can include computer-readable storage media embodied in or including any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With further reference to FIG. 19, the example computing environment 1900 for implementing various aspects of the specification includes a computing device 1902. In certain embodiments, the computing device 1902 can embody or can include the mobile device 160 and/or the mobile device 770. In other embodiments, the computing device 1902 can embody or can constitute the commerce agent system 710. In yet other embodiments, the computing device 1902 can embody or can constitute the location monitoring system 120. In still other embodiments, the example computing environment 1900 can embody or can constitute a combination of systems and component(s) thereof in accordance with aspects of this disclosure described herein. As illustrated, the computing device 1902 includes a processing unit 1904, a system memory 1906 and a system bus 1908. The system bus 1908 couples system components including, but not limited to, the system memory 1906 to the processing unit 1904. The processing unit 1904 can be any of various commercially available processors. Dual microprocessors and other multi-processor architectures may also be employed as the processing unit 1904.

The system bus 1908 can be any of several types of bus structure that may further interconnect to a memory bus (with or without a memory controller), a peripheral bus, and a local bus using any of a variety of commercially available bus architectures. The system memory 1906 includes read-only memory (ROM) 1910 and random access memory (RAM) 1912. A basic input/output system (BIOS) is stored in a non-volatile memory 1910 such as ROM, EPROM, EEPROM, which BIOS contains the basic routines that help to transfer information between elements within the computing device 1902, such as during start-up. The RAM 1912 can also include a high-speed RAM such as static RAM for caching data.

The computing device 1902 further includes an internal hard disk drive (HDD) 1914 (e.g., EIDE, SATA), which internal hard disk drive 1914 may also be configured for external use in a suitable chassis (not shown), or an external HDD 1915 can be present in addition to internal HDD 1914, a magnetic floppy disk drive (FDD) 1916, (e.g., to read from or write to a removable diskette 1918) and an optical disk drive 1920, (e.g., reading a CD-ROM disk 1922 or, to read from or write to other high capacity optical media such as the DVD). The hard disk drive 1914, magnetic disk drive 1916 and optical disk drive 1920 can be connected to the system bus 1908 by a hard disk drive interface 1924, a magnetic disk drive interface 1926 and an optical drive interface 1928, respectively. The interface 1924 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computing device 1902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1912, including an operating system 1930, one or more application programs 1932, other program modules 1934 and program data 1936. All or portions of the operating system, applications, modules, and/or data can also be cached in the RAM 1912. It is appreciated that the specification can be implemented with various commercially available operating systems or combinations of operating systems. At least one of the program modules 1934 can include, for example, computer-accessible instructions (e.g., computer-executable instructions and/or computer-readable instructions) that, in response to execution by the processing unit 1904, can permit the computing device 1902 and/or one or more of the remote computer(s) 1948 to perform or otherwise facilitate performance of operations that provide the functionalities described herein in accordance with embodiments of this disclosure, such as implementing the example methods described herein. In certain implementations, such computer-accessible instructions also can be executed by another processing unit (such as a processor in one of the remote computer(s) 1948) in order to implement various functionalities in accordance with aspects of this disclosure. At least a portion of the program data 1936 can be utilized or otherwise leveraged during execution of one or more of the program modules 1934 in order for the computing device 1902 to operate in accordance with aspects described herein in accordance with embodiments of this disclosure. In certain embodiments, at least one the program modules 1934, in response to execution by the computing device 1902, can provide at least the functionality of the mobile device 160 and/or the mobile device 770 in accordance with aspects described herein in connection with FIGS. 10-12 and/or other embodiments of this disclosure.

A user can enter commands and information into the computing device 1902 through one or more wired/wireless input devices, e.g., a keyboard 1938 and a pointing device, such as a mouse 1940. Other input devices (not shown) may include a microphone, an IR remote control, a joystick, a game pad, a stylus pen, touch screen, or the like. These and other input devices are often connected to the processing unit 1904 through an input device interface 1942 that is coupled to the system bus 1908, but can be connected by other interfaces, such as a parallel port, an IEEE 1394 serial port, a game port, a USB port, an IR interface, etc.

A monitor 1944 or other type of display device is also connected to the system bus 1908 via an interface, such as a video adapter 1946. In addition to the monitor 1944, a computer typically includes other peripheral output devices (not shown), such as speakers, printers, etc.

The computing device 1902 can operate in a networked environment using logical connections via wired and/or wireless communications to one or more remote computers, such as a remote computer(s) 1948. The remote computer(s) 1948 can be a workstation, a server computer, a router, a personal computer, portable computer, microprocessor-based entertainment appliance, a peer device or other common network node, and typically includes many or all of the elements described relative to the computing device 1902, although, for purposes of brevity, only a memory/storage device 1950 is illustrated. The logical connections depicted include wired/wireless connectivity to a local area network (LAN) 1952 and/or larger networks, e.g., a wide area network (WAN) 1954. Such LAN and WAN networking environments are commonplace in offices and companies, and facilitate enterprise-wide computer networks, such as intranets, all of which may connect to a global communications network, e.g., the Internet.

When used in a LAN networking environment, the computing device 1902 is connected to the local network 1952 through a wired and/or wireless communication network interface or network adapter 1956. The network adapter 1956 can permit or otherwise facilitate wired or wireless communication to the LAN 1952, which may also include a wireless access point disposed thereon for communicating with the network adapter 1956.

When used in a WAN networking environment, the computing device 1902 can include a modem 1958, or is connected to a communications server on the WAN 1954, or has other means for establishing communications over the WAN 1954, such as by way of the Internet. The modem 1958, which can be internal or external and a wired or wireless device, is connected to the system bus 1908 via the serial port interface 1942. In a networked environment, program modules depicted relative to the computing device 1902, or portions thereof, can be stored in the remote memory/storage device 1950. It will be appreciated that the network connections shown are example and other means of establishing a communications link between the computers can be used.

The computing device 1902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi, ZigBee®, Bluetooth™, and/or other types of proprietary and non-proprietary wireless technologies. Thus, the communication can be a predefined structure as with a conventional network or simply an ad hoc communication between at least two devices. To that end, in certain embodiments, the computing device 1902 can include a radio unit that can receive information wirelessly from a remote computing device. The radio unit can be included in the network adapter 1956, for example, and can include one or more antenna(s) (not shown) that can receive data or other type of information wirelessly. Each of the data and the information can be modulated and/or encoded according to a specific radio technology protocol for cellular wireless communication, small-cell wireless communication, and/or point-to-point wireless communication.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks can operate in the unlicensed 2.4 and 5 GHz radio bands, at a 9 Mbps (802.11a) or 54 Mbps (802.11b) data rate, for example, or with products that contain both bands (dual band), so the networks can provide real-world performance similar to the basic 10 BaseT wired Ethernet networks used in many offices.

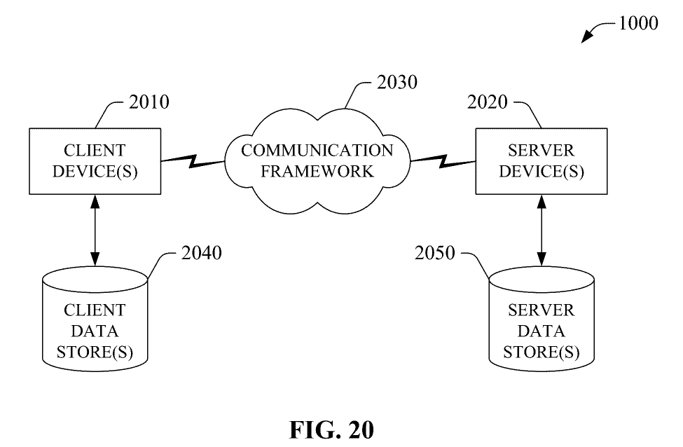

FIG. 20 illustrates a schematic block diagram of an example computing system 2000, in accordance with aspects described herein. The example computing system 2000 includes one or more client devices 2010. The client devices(s) 2010 can be embodied in or can include hardware and/or software (e.g., threads, processes, computing devices). The example computing system 2000 also includes one or more server device(s) 2020. Thus, example computing system 2000 can correspond to a two-tier client server model or a multi-tier model (e.g., client, middle tier server, data server), amongst other models. The server device(s) 2020 also can be embodied in or can include hardware and/or software (e.g., threads, processes, computing devices). The server device(s) 2020 can house threads to perform transformations by employing the subject disclosure, for example. One possible communication between a client device of the client device(s) 2010 and a server device of the server device(s) 2020 may be in the form of a data packet transmitted between two or more computer processes.

The example computing system 2000 also includes a communication framework 2030 that can be employed to permit or otherwise facilitate communications between a client device of the client(s) 2010 and a server device of the server device(s) 2020. The client device(s) 2010 can be operatively connected to one or more client data store(s) 2040 that can be employed to store information local to the client device(s) 2010. Similarly, the server device(s) 2020 are operatively connected to one or more server data store(s) 2050 that can be employed to store information local to the server device(s) 2020.

In the present description, for purposes of explanation, numerous specific details have been set forth in order to provide a thorough understanding of the disclosure. It may be evident, however, that the subject disclosure may be practiced without these specific details. In other instances, well-known structures and devices are shown in block diagram form in order to facilitate describing the subject disclosure.

As used in this disclosure, including the annexed drawings, the terms “component,” “system,” “platform,” “unit,” “function,” “interface,” and the like are intended to refer to a computer-related entity or an entity related to an operational apparatus with one or more specific functionalities, wherein the entity can be either hardware, a combination of hardware and software, software, or software in execution. One or more of such entities are also referred to as “functional elements.” As an example, a component may be, but is not limited to being, a process running on a processor, a processor, an object, an executable, a thread of execution, a program, and/or a computer. By way of illustration, both an application running on a server or network controller, and the server or network controller can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software, or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, node, coder, decoder, and the like.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment,” “mobile station,” “mobile,” subscriber station,” “subscriber equipment,” “access terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings.

Furthermore, the terms “user,” “subscriber,” “customer,” “consumer,” “pro sumer,” “agent,” and the like are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms) which can provide simulated vision, sound recognition and so forth.

The term “processor,” as utilized in this disclosure, can refer to any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various embodiments described herein can be implemented as a method, apparatus, or article of manufacture using standard programming and/or engineering techniques. In addition, various of the aspects disclosed herein also can be implemented through program modules stored in a memory and executed by a processor, or other combination of hardware and software, or hardware and firmware. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ).

What has been described above includes examples of systems and methods that provide advantages of the subject disclosure. It is, of course, not possible to describe every conceivable combination of components or methodologies for purposes of describing the subject disclosure, but one of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
in response to a determination of an event, determining, by a system comprising a processor, user devices having respective social networking relationships with a mobile device;
determining network devices associated with transactions related to the mobile device;
sending, by the system, location information indicative of a current location of the mobile device to a network device of the network devices;
accessing, by the system from the network device, promotional content based on the current location of the mobile device; and
sending, by the system, at least a portion of the promotional content and the location information indicative of the current location of the mobile device to a user device of the user devices.

2. The method of claim 1, further comprising:
receiving, by the system, transaction information associated with a commercial transaction between the user device and the network device, wherein the network device is an electronic commerce platform device; and
performing, by the system, at least a portion of the commercial transaction.

3. The method of claim 1, wherein the determining the user devices having the respective social networking relationships with the mobile device comprises analyzing transactional information associated with the mobile device stored by a home subscriber server device, and wherein the transactional information comprises information representative of usage of a service by the mobile device.

4. The method of claim 1, wherein the determination of the event comprises a determination that the event has commenced, and wherein the determining the user devices having the respective social networking relationships with the mobile device comprises analyzing a device profile of the mobile device stored by a home subscriber server device.

5. The method of claim 1, further comprising:
ranking, by the system, the user devices having the respective social networking relationships according to respective values determined according to a relationship relevancy criterion; and
prior to the sending at least the portion of the promotional content and the location information indicative of the current location of the mobile device, selecting, by the system, the user device based on a rank of the user device.

6. The method of claim 5, wherein the ranking the user devices comprises:
associating nodes in a graph representation with respective ones of the user devices; and
determining a distance between a first node of the nodes representative of a first user device of the user devices and a second node of the nodes representative of a second device of the user devices.

7. The method of claim 1, wherein the sending at least the portion of the promotional content and the location information comprises sending a text message to the user device,
wherein the text message comprises at least one hyperlink configured to direct the device:
to display a first graphical marking representative of the current location of the mobile device, and
to display a second graphical marking representative of at least the portion of the promotional content, and
wherein the second graphical marking comprises a selectable indicium that, in response to selection, directs the user device to initiate a commercial transaction between the user device and the network device.

8. A system, comprising:
a processor; and
a memory that stores executable instructions that, when executed by the processor, facilitate performance of operations, comprising:
receiving an estimate of a current location of a mobile device;
determining that the current location of the mobile device is associated with a social event based on a result of comparing the estimate of the current location of the mobile device to venue information of the social event; and
in response to the determining,
determining a network device based on a commerce preference associated with the mobile device, wherein the network device is communicatively coupled to the mobile device and is associated with the social event;
receiving promotional content in response to a request that the network device provides the promotional content; and
sending the venue information, event information other than the venue information, and at least a portion of the promotional content to the mobile device.

9. The system of claim 8, wherein the sending at least the portion of the promotional content comprises sending an instruction to the mobile device to:
display deal information associated with at least the portion of the promotional content, and
display a selectable indicium that, in response to selection, directs the mobile device to initiate a secure communication session for a commerce transaction with the network device, and
wherein the network device comprises an electronic commerce device.

10. The system of claim 9, wherein the operations further comprise:
initiating the secure communication session; and
performing an operation associated with the commerce transaction between the mobile device and the network device.

11. The system of claim 8, wherein the operations further comprise:
determining user devices having respective social networking associations with the mobile device; and
determining relationship categories corresponding to the user devices.

12. The system of claim 11, wherein the operations further comprise:
sending at least the portion of the promotional content to a user device determined to pertain to a defined relationship category.

13. The system of claim 11, wherein the operations further comprise:
receiving another estimate of a current location of a user device determined to pertain to a defined relationship category.

14. The system of claim 13, wherein the operations further comprise:
sending a text message comprising the other estimate of the current location of the user device to the mobile device, and wherein the text message comprises executable information configured to direct the mobile device to display an indicium indicative of the other estimate of the current location of the device.

15. A computer-readable storage device comprising executable instructions that, in response to execution, cause a system comprising a processor to facilitate performance of operations, comprising:
receiving a notification that an emergency alert associated with a mobile device is active; and
in response to the receiving the notification,
requesting a network device to update a device profile of the mobile device to comprise an authorization configuration indicative of a permission to track a location of the mobile device, wherein an initial configuration of the authorization configuration is stored by a storage device of a communication network in connection with a process of provisioning the mobile device, and wherein the network device is configured to modify device profiles stored by the storage device,
determining a user equipment having a social relationship with the mobile device, and
determining an estimate of a current location of the mobile device.

16. The computer-readable storage device of claim 15, wherein the operations further comprise, in further response to the receiving the notification, sending location information indicative of the estimate of the current location of the mobile device to the user equipment.

17. The computer-readable storage device of claim 16, wherein the sending the location information comprises sending a text message comprising geographic coordinates indicative of the estimate of the current location of the mobile device.

18. The computer-readable storage device of claim 16, wherein the operations further comprise:
monitoring a deactivation status of the emergency alert; and
terminating the sending the location information in response to the deactivation status indicating that the emergency alert has become inactive.

19. The computer-readable storage device of claim 15, wherein the determining the estimate of the current location of the mobile device comprises:
directing another system to provide the estimate of the current location of the mobile device; and
receiving location information indicative of the estimate of the current location of the mobile device from the other system.

20. The computer-readable storage device of claim 19, wherein the receiving the location information comprises receiving a second message comprising a hyperlink associated with geographic coordinates indicative of the estimate of the current location of the mobile device, and wherein selection of the hyperlink directs the user equipment to execute a web application according to information associated with the hyperlink.
